(19) United States
(12) Patent Application Publication
(10) Pub. No.: US 2024/0349306 A1
(43) Pub. Date: Oct. 17, 2024

(54) Methods, UE, Network Node, Media for SL Transmission with Dedicated Resource Pool

(71) Applicant: Telefonaktiebolaget LM Ericsson (pub), Stockholm (SE)

(72) Inventors: Zhang Zhang, Beijing (CN); Min Wang, Luleå (SE)

(21) Appl. No.: 18/580,443

(22) PCT Filed: Jun. 30, 2022
(86) PCT No.: PCT/CN2022/102800

§ 371 Date: Jan. 18, 2024

(30) Foreign Application Priority Data
Jul. 21, 2021 (WO) PCT/CN2021/107724

(51) Int. Cl. H04W 72/25; H04W 28/02; H04W 72/56

(52) U.S. Cl. CPC H04W 72/25; H04W 28/0268; H04W 72/56

(57) ABSTRACT

Methods (100, 200), a UE (300, 400), a network node (500, 600), and computer readable storage media for SL transmission with a dedicated resource pool are disclosed. The method (100) at the UE includes: in a case where the UE has a first type of SL message available for transmission, obtaining an SL grant, wherein the SL grant indicates resources belonging to a dedicated resource pool that is dedicated for transmission of the first type of SL message; and performing (S103) actions related to the transmission of the first type of SL message on at least a part of the resources indicated in the SL grant, by taking into consideration priorities of SLCHs used to carry the first type of SL message.

### TECHNICAL FIELD

The present disclosure relates to wireless communications, and in particular, to methods, a User Equipment (UE), a network node, and computer readable storage media for sidelink (SL) transmission with a dedicated resource pool.

### BACKGROUND

This section is intended to provide a background to the various embodiments of the technology described in this disclosure. The description in this section may include concepts that could be pursued, but are not necessarily ones that have been previously conceived or pursued. Therefore, unless otherwise indicated herein, what is described in this section is not prior art to the description and/or claims of this disclosure and is not admitted to be prior art by the mere inclusion in this section.

### Sidelink Transmissions In New Radio (NR)

The link or radio link over which signals are transmitted between at least two UEs for Device-to-Device (D2D) operations is called herein as a sidelink (which is interchangeable with its abbreviation ‘SL’). The signals transmitted between the UEs for D2D operations are called herein as SL signals. The term SL may also interchangeably be called as a D2D link, a Vehicle-to-Everything (V2X) link, a Proximity-based Services (ProSe) link, a peer-to-peer link, a PC5 link etc. The SL signals may also interchangeably be called as D2D signals, V2X signals, ProSe signals, peer-to-peer signals, PC5 signals, etc.

SL transmissions over NR are specified for Rel. 16. These are enhancements of the ProSe specified for Long Term Evolution (LTE).

Similar as for ProSe in LTE, NR sidelink transmissions have the following two modes of resource allocations:
Mode 1: Sidelink resources are scheduled by a network node, such as gNB.
Mode 2: The UE autonomously selects sidelink resources from a (pre-) configured sidelink resource pool(s) based on the channel sensing mechanism.

For the in-coverage UE, a network node, such as a gNB, can be configured to adopt Mode 1 or Mode 2. For the out-of-coverage UE, only Mode 2 can be adopted.

As in LTE, scheduling over the sidelink in NR is done in different ways for Mode 1 and Mode 2.

### Sidelink Logical Channel Prioritization (LCP)

The sidelink LCP procedure is applied when a new sidelink transmission is performed. Each SLCH has an associated priority which is ProSe Per-Packet Priority (PPPP) in LTE and optionally an associated ProSe Per-Packet Reliability (PPPR). In NR, the associated priority and reliability may be derived from the QoS profile of the sidelink radio bearer.

### SUMMARY

Embodiments of the present disclosure propose mechanisms to facilitate SL transmission, e.g., PSSCH transmission, when a resource pool (referred to as a “dedicated resource pool”) dedicated for transmission of a specific type of SL message (i.e., which is allowed to use resources in the dedicated resource pool for transmission) is configured by a network node, or preconfigured in a UE.

The basic ideas of the present disclosure mainly consist in that:
when resources indicated in a received/selected SL grant belong to the dedicated resource pool for transmission of a specific type of SL message, e.g. a discovery message or traffic, the highest priority of SLCHs used to carry or carrying the specific type of SL message is used in sidelink LCP (including destination selection and prioritization among SLCHs associated with the selected destination), prioritization between UL transmission and SL transmission, and transmission parameters selection for an SL channel, e.g. PSSCH;
when performing sensing in the dedicated resource pool for transmission of the specific type of SL message, e.g. a discovery message or traffic, the highest priority of SLCHs carrying the specific type of SL message is used to determine the sensing threshold;
when performing preemption in the dedicated resource pool for transmission of the specific type of SL message, e.g. a discovery message or traffic, the highest priority of SLCHs carrying the specific type of SL message is used to determine whether a resource in the dedicated resource pool can be preempted;
criteria for pool selection are proposed when both a shared resource pool and a dedicated resource pool are configured by the network node, or preconfigured in the UE; and
in a case where the highest priority of SLCH(s) carrying a specific type of message that is allowed to use resources in the dedicated resource pool for transmission is lower than the highest priority of SLCH(s) carrying another type of message that is not allowed to use resources in the dedicated resource pool for transmission, e.g., other traffic, or there is available for transmission only the other type of message that is not allowed to use resources in the dedicated resource pool for transmission, and the resources indicated in all the available SL grant(s) are within the dedicated resource pool, a Mode 1 UE may send an SL SR/BSR to the network node to request (additional) SL resources.

According to a first aspect of the present disclosure, a method at a first UE is provided. The method includes: in a case where the UE has a first type of SL message available for transmission, obtaining a SL grant, wherein the SL grant indicates resources belonging to a dedicated resource pool that is dedicated for transmission of the first type of SL message; and performing actions related to the transmission of the first type of SL message on at least a part of the resources indicated in the SL grant, by taking into consideration priorities of SLCHs used to carry the first type of SL message.

In an exemplary embodiment, said performing the actions includes: selecting a destination from a plurality of destinations to which the transmission of the first type of SL message is to be performed, based on a highest priority of SLCHs used to carry the first type of SL message that are associated with each of the plurality of destinations, wherein the selected destination has an SLCH with the highest priority; and assigning the resources indicated in the SL grant to one or more SLCHs used to carry the first type of SL message that are associated with the selected destination, for the transmission of the first type of SL message, based on the priorities of the one or more SLCHs used to carry the first type of SL message that are associated with the selected destination.

In an exemplary embodiment, said performing the actions includes: in a case where prioritization between UL transmission and SL transmission is needed for the UE, performing prioritization based on the highest priority of the one or more SLCHs carrying or used to carry the first type of SL message and a highest priority of one or more Logical Channels (LCHs) carrying or used to carry UL messages; and performing transmission of the UL messages if the UL transmission is prioritized, otherwise performing the transmission of the first type of SL message.

In an exemplary embodiment, the transmission of the first type of SL message is performed if the highest priority of the one or more SLCHs carrying or used to carry the first type of SL message is smaller than an SL prioritization threshold, while the highest priority of the one or more LCHs carrying or used to carry the UL message is larger than an UL prioritization threshold; and the transmission of the UL messages is performed, if the highest priority of the one or more SLCHs carrying or used to carry the first type of SL message is larger than an SL prioritization threshold, or the highest priority of the one or more LCHs carrying or used to carry the type of UL message is smaller than an UL prioritization threshold.

In an exemplary embodiment, a specific value for the SL prioritization threshold is configured by a network node or preconfigured in the UE, which is applied when the resources indicated by the SL grant belong to the dedicated resource pool.

In an exemplary embodiment, said performing the actions includes: building an SL MAC PDU only including the one or more SLCHs used to carry the first type of SL message.

In an exemplary embodiment, the first type of SL message includes a plurality of the first types of SL messages.

In an exemplary embodiment, the one or more SLCHs used to carry the plurality of the first types of SL messages are multiplexed in the SL MAC PDU.

In an exemplary embodiment, the method further includes: obtaining configuration on SL transmission parameters; and wherein said performing (S103) the actions includes: selecting SL transmission parameters for the transmission of the first type of SL message based on the highest priority of the SLCHs used to carry the first type of SL message.

In an exemplary embodiment, said obtaining the SL grant includes: receiving the SL grant from a network node, and the method further includes: identifying whether the resources indicated in the SL grant belong to the dedicated resource pool for the transmission of the first type of SL message based on one of:
a pool ID included in Downlink Control Information ‘DCI’ for indicating a resource pool associated with the SL grant, in a case where the SL grant is a dynamic SL grant; and
pool configuration in Radio Resource Control ‘RRC’ signaling, in a case where the SL grant is a configured SL grant, wherein the pool configuration is associated to a pool ID for indicating a resource pool.

In an exemplary embodiment, said obtaining the SL grant includes: generating the SL grant based on the resources selected from the dedicated resource pool.

In an exemplary embodiment, the method further includes: performing resource selection in the dedicated resource pool based on channel sensing, by taking into consideration the priorities of the SLCHs carrying or used to carry the first type of SL message.

In an exemplary embodiment, said performing resource selection includes: decoding SCI transmitted on an SL control channel from a sensed UE to know resources on which an associated SL data channel is transmitted by the sensed UE and the highest priority of the SLCH associated with the SL data channel; and determining availability of the resources in the dedicated resource pool on which the SL data channel is transmitted, based on comparison of a measured value of link quality of the SL control channel with a predetermined threshold of link quality, wherein the predetermined threshold of link quality is set based on the highest priority of the SLCHs carrying or used to carry the first type of SL message.

In an exemplary embodiment, the method further includes: obtaining configuration on preemption of resources in the dedicated resource pool that are preserved by SCI received from a neighbor UE, for the transmission of the first type of SL message that is allowed to use resources in the dedicated resource pool for transmission; and in the case where the UE has the first type of SL message available for transmission, comparing a highest priority of SLCHs carrying or used to carry the first type of SL message with a priority indicated in the received SCI; and determining to preempt the resources preserved by the received SCI, if the highest priority of the SLCHs carrying or used to carry the first type of SL message is higher than the priority indicated in the received SCI.

In an exemplary embodiment, the dedicated resource pool is configured by a network node or preconfigured in the UE for the transmission of the first type of SL message.

In an exemplary embodiment, the dedicated resource pool and a shared resource pool are configured by a network node or preconfigured in the UE for the transmission of the first type of SL message.

In an exemplary embodiment, the method further includes:
performing pool selection between the dedicated resource pool and the shared resource pool according to at least one of selection criteria, in which
   the shared resource pool is selected, if the UE has available for transmission both the first type of SL message and a second type of SL message that is not allowed to use the resources in the dedicated resource pool for transmission, or if the UE has available for transmission only the second type of SL message; while the dedicated resource pool is selected if the UE has available for transmission only the first type of SL message;
   the shared resource pool is selected if the highest priority of the SLCHs used to carry the first type of SL message is not higher than that of SLCHs used to carry the second type of SL message, while the dedicated resource pool is selected if the highest priority of the SLCHs used to carry the first type of SL message is higher than that of SLCHs used to carry the second type of SL message;
   a type of resource pool with a higher priority is selected, wherein a resource pool is randomly selected or a resource pool with a lowest congestion is selected if there are a plurality of resources pools belonging to the selected pool type, in a case where different priority values are configured by the network node or preconfigured in the UE respectively for the dedicated resource pool and the shared resource pool;
   a type of resource pool is selected according to configuration by the network node or preconfiguration in the UE, in which case a resource pool is randomly selected or a resource pool with a lowest congestion is selected if there are a plurality of resources pools belonging to the selected pool type;
   a resource pool with a lower congestion is selected, regardless of the type of the pool;
   the UE transmits a preference indication on the pool selection to the network node, receives acceptance of the preference indication from the network node, and selects a type of resource pool based on the preference indication;
   the UE transmits a preference indication on the pool selection to the network node, receives another preference indication from the network node, and selects a type of resource pool based on the received preference indication;
   it is up to implementation of the UE to select which type of resource pool.

In an exemplary embodiment, the preference indication on the pool selection is carried via at least one of:
RRC signaling,
a MAC CE,
a control PDU of a protocol layer,
an L1 signaling carried in a physical channel,
specific Random Access Channel (RACH) resources.

In an exemplary embodiment, the method further includes: receiving separate SR configurations associated with different types of resource pools respectively; and transmitting an SR for signaling the preference indication using one of the separate SR configurations, in a case where the UE has the first type of SL message available for transmission.

In an exemplary embodiment, the dedicated resource pool is selected.

In an exemplary embodiment, the method further includes: receiving, from the network node, configuration on a specific SL Logical Channel Group (SLCG) that at least include an SLCH used to carry the first type of SL message; and transmitting, to the network node, an SL BSR including the configured specific SLCG in the case where the UE has the first type of SL message available for transmission.

In an exemplary embodiment, the method further includes: receiving, from the network node, configuration on an SR that is associated with an SLCH and/or SLCG used to carry the first type of SL message; and triggering the configured SR, in the case where the UE has the first type of SL message available for transmission; and transmitting the configured SR to the network node.

In an exemplary embodiment, the method further includes: in a case where the highest priority of SLCHs used to carry the first type of SL message is lower than the highest priority of SLCHs used to carry a second type of SL message that is not allowed to use the dedicated resource pool for transmission, or in a case where the UE has available for transmission only a second type of SL message that is not allowed to use the dedicated resource pool for transmission, and the UE has only an available SL grant indicating resources belonging to the dedicated resource pool, triggering an SR for requesting additional resources for the second type of SL message; and transmitting the SR to the network node.

In an exemplary embodiment, the method further includes: after the type of resource pool is selected, switching to another type of resource pool due to at least one of reasons of:
congestion in the selected resource pool being higher than a predetermined threshold,
measured transmission performance using the selected resource pool become being higher than a threshold,
measured Quality of Service (QOS) metrics using the selected resource pool not meeting specific requirements,
services/applications/traffic types that are associated with different resource pools and have available data having changed, or
the UE's battery life having changed.

In an exemplary embodiment, at least one of the configuration on SL transmission parameters, the configuration on preemption, the separate SR configurations associated with different types of resource pools respectively, the configuration on the specific SLCG that at least includes an SLCH used to carry the first type of SL message, and the configuration on the SR that is associated with the SLCH and/or SLCG used to carry the first type of SL message are transmitted is carried via at least one of:
RRC signaling,
a MAC CE,
a control PDU of a protocol layer,
an L1 signaling carried in a physical channel.

In an exemplary embodiment, the first type of SL message at least includes one of:
discovery message, or
SL traffic, which includes at least one of:
SL data,
SL signaling, or
SL MAC CE.

According to a second aspect of the present disclosure, a method at a network node is provided. The method includes: transmitting, to a UE, configuration on transmission of a first type of SL message that is allowed to use resources in a dedicated resource pool for transmission.

In an exemplary embodiment, the method further includes: transmitting an SL grant to the UE, wherein the SL grant indicates resources belonging to the dedicated resource pool that is dedicated for the transmission of the first type of SL message.

In an exemplary embodiment, the configuration includes: configuration on preemption of resources in the dedicated resource pool that are preserved by SCI received from a neighbor UE for the transmission of the first type of SL message that is allowed to use resources in the dedicated resource pool for transmission.

In an exemplary embodiment, the dedicated resource pool is configured by the network node for the transmission of the first type of SL message.

In an exemplary embodiment, the dedicated resource pool and a shared resource pool are configured by a network node for the transmission of the first type of SL message.

In an exemplary embodiment, the method further includes:

performing pool selection between the dedicated resource pool and the shared resource pool according to at least one of selection criteria, in which
the shared resource pool is selected, if the UE has available for transmission both the first type of SL message and a second type of SL message that is not allowed to use the resources in the dedicated resource pool for transmission, or if the UE has available for transmission only the second type of SL message; while the dedicated resource pool is selected if the UE has available for transmission only the first type of SL message;
the shared resource pool is selected if the highest priority of the SLCHs used to carry the first type of SL message is not higher than that of SLCHs used to carry the second type of SL message, while the dedicated resource pool is selected if the highest priority of the SLCHs used to carry the first type of SL message is higher than that of SLCHs used to carry the second type of SL message;
a type of resource pool with a higher priority is selected, wherein a resource pool is randomly selected or a resource pool with a lowest congestion is selected if there are a plurality of resources pools belonging to the selected pool type, in a case where different priority values are configured by the network node respectively for the dedicated resource pool and the shared resource pool;
a type of resource pool is selected according to configuration by the network node, in which case a resource pool is randomly selected or a resource pool with a lowest congestion is selected if there are a plurality of resources pools belonging to the selected pool type;
a resource pool with a lower congestion is selected, regardless of the type of the pool;
the network node receives a preference indication from the UE on the pool selection, and selects a type of resource pool taking into consideration the preference indication;
the network node receives the preference indication from the UE on the pool selection, and transmits acceptance of the preference indication to the UE;
it is up to implementation of the network node to select which type of resource pool.

In an exemplary embodiment, the preference indication on the pool selection is carried via at least one of:
RRC signaling,
a MAC CE,
a control PDU of a protocol layer,
an L1 signaling carried in a physical channel,
specific RACH resources.

In an exemplary embodiment, the configuration includes: separate SR configurations associated with different types of resource pools respectively for the UE to use one of the separate SR configurations to transmit an SR for signaling the preference indication.

In an exemplary embodiment, the dedicated resource pool is selected.

In an exemplary embodiment, the configuration includes: configuration on a specific SLCG that at least includes an SLCH used to carry the first type of SL message; and the method further includes: receiving, from the UE, an SL BSR including the configured specific SLCG in the case where the UE has the first type of SL message available for transmission.

In an exemplary embodiment, the configuration includes: configuration on an SR that is associated with an SLCH and/or SLCG used to carry the first type of SL message; and the method further includes: receiving the configured SR from the UE, in the case where the UE has the first type of SL message available for transmission.

In an exemplary embodiment, the method further includes: receiving, from the UE, an SR for requesting additional resources for the second type of SL message.

In an exemplary embodiment, the method further includes: after the type of resource pool is selected, switching to another type of resource pool due to at least one of reasons of:
congestion in the selected resource pool being higher than a predetermined threshold,
measured transmission performance using the selected resource pool become being higher than a threshold,
measured QoS metrics using the selected resource pool not meeting specific requirements,
services/applications/traffic types that are associated with different resource pools and have available data having changed, or
the UE's battery life having changed.

In an exemplary embodiment, the configuration on transmission of the first type of SL message is carried via at least one of:
RRC signaling,
a MAC CE,
a control PDU of a protocol layer,
an L1 signaling carried in a physical channel.

In an exemplary embodiment, the first type of SL message at least includes one of:
discovery message, or
SL traffic, which includes at least one of:
SL data,
SL signaling, or
SL MAC CE.

In an exemplary embodiment, the first type of SL message includes a plurality of the first types of SL messages.

According to a third aspect of the present disclosure, a UE is provided. The first UE includes: at least one processor, and at least one memory, storing instructions which, when executed on the at least one processor, cause the first UE to perform any of the methods according to the first aspect of the present disclosure.

According to a fourth aspect of the present disclosure, a network node is provided. The network node includes: at least one processor, and at least one memory, storing instructions which, when executed on the at least one processor, cause the network node to perform any of the methods according to the second aspect of the present disclosure.

According to a fifth aspect of the present disclosure, a computer readable storage medium is provided. The computer readable storage medium has computer program instructions stored thereon, the computer program instructions, when executed by at least one processor, causing the at least one processor to perform any of the methods according to any of the first to second aspects of the present disclosure.

According to a sixth aspect of the present disclosure, a communication system is provided. The communication system includes a host computer including: processing circuitry configured to provide user data; and a communication interface configured to forward the user data to a cellular network for transmission to a UE. The cellular network includes a network node, a transmission point, relay node, or an UE having a radio interface and processing circuitry. The network node's processing circuitry is configured to perform any of the methods according to the second aspect of the present disclosure.

In an exemplary embodiment, the communication system can further include the network node.

In an exemplary embodiment, the communication system can further include the UE. The UE is configured to communicate with the network node.

In an exemplary embodiment, the processing circuitry of the host computer can be configured to execute a host application, thereby providing the user data. The UE can include processing circuitry configured to execute a client application associated with the host application.

According to a seventh aspect of the present disclosure, a method is provided. The method is implemented in a communication system including a host computer, a network node and a UE. The method includes: at the host computer, providing user data; and at the host computer, initiating a transmission carrying the user data to the UE via a cellular network including the network node. The network node can perform any of the methods according to the second aspect of the present disclosure.

In an exemplary embodiment, the method further can include: at the network node, transmitting the user data.

In an exemplary embodiment, the user data can be provided at the host computer by executing a host application. The method can further include: at the UE, executing a client application associated with the host application.

According to an eighth aspect of the present disclosure, a communication system is provided. The communication system includes a host computer including: processing circuitry configured to provide user data; and a communication interface configured to forward user data to a cellular network for transmission to a UE. The UE includes a radio interface and processing circuitry. The UE's processing circuitry is configured to perform any of the methods according to the first aspect of the present disclosure.

In an exemplary embodiment, the communication system can further include the UE.

In an exemplary embodiment, the cellular network can further include a network node configured to communicate with the UE.

In an exemplary embodiment, the processing circuitry of the host computer can be configured to execute a host application, thereby providing the user data. The UE's processing circuitry can be configured to execute a client application associated with the host application.

According to a ninth aspect of the present disclosure, a method is provided. The method is implemented in a communication system including a host computer, a network node and a UE. The method includes: at the host computer, providing user data; and at the host computer, initiating a transmission carrying the user data to the UE via a cellular network including the network node. The UE can perform any of the methods according to the first aspect of the present disclosure.

In an exemplary embodiment, the method can further include: at the UE, receiving the user data from the network node.

According to a tenth aspect of the present disclosure, a communication system is provided. The communication system includes a host computer including: a communication interface configured to receive user data originating from a transmission from a UE to a network node.

The UE includes a radio interface and processing circuitry. The UE's processing circuitry is configured to: perform any of the methods according to the first aspect of the present disclosure.

In an exemplary embodiment, the communication system can further include the UE.

In an exemplary embodiment, the communication system can further include the network node. The network node can include a radio interface configured to communicate with the UE and a communication interface configured to forward to the host computer the user data carried by a transmission from the UE to the network node.

In an exemplary embodiment, the processing circuitry of the host computer can be configured to execute a host application. The UE's processing circuitry can be configured to execute a client application associated with the host application, thereby providing the user data.

In an exemplary embodiment, the processing circuitry of the host computer can be configured to execute a host application, thereby providing request data. The UE's processing circuitry can be configured to execute a client application associated with the host application, thereby providing the user data in response to the request data.

According to an eleventh aspect of the present disclosure, a method is provided. The method is implemented in a communication system including a host computer, a network node and a UE. The method includes: at the host computer, receiving user data transmitted to the network node from the UE. The UE can perform any of the methods according to the first aspect of the present disclosure.

In an exemplary embodiment, the method can further include: at the UE, providing the user data to the network node.

In an exemplary embodiment, the method can further include: at the UE, executing a client application, thereby providing the user data to be transmitted; and at the host computer, executing a host application associated with the client application.

In an exemplary embodiment, the method can further include: at the UE, executing a client application; and at the UE, receiving input data to the client application, the input data being provided at the host computer by executing a host application associated with the client application. The user data to be transmitted is provided by the client application in response to the input data.

According to a twelfth aspect of the present disclosure, a communication system is provided. The communication system includes a host computer including a communication interface configured to receive user data originating from a transmission from a UE to a network node. The network node includes a radio interface and processing circuitry. The network node's processing circuitry is configured to perform any of the methods according to the second aspect of the present disclosure.

In an exemplary embodiment, the communication system can further include the network node.

In an exemplary embodiment, the communication system can further include the UE. The UE can be configured to communicate with the network node.

In an exemplary embodiment, the processing circuitry of the host computer can be configured to execute a host application; the UE can be configured to execute a client application associated with the host application, thereby providing the user data to be received by the host computer.

According to a thirteenth aspect of the present disclosure, a method is provided. The method is implemented in a communication system including a host computer, a network node and a UE. The method includes: at the host computer, receiving, from the network node, user data originating from a transmission which the network node has received from the UE. The network node can perform any of the methods according to the second aspect of the present disclosure.

In an exemplary embodiment, the method can further include: at the network node, receiving the user data from the UE.

In an exemplary embodiment, the method can further include: at the network node, initiating a transmission of the received user data to the host computer.

With the technical solutions according to the exemplary embodiments of the present disclosure as described above, the above procedures in which an SLCH priority needs to be considered, such as sidelink LCP, prioritization between UL transmission and SL transmission, transmission parameters selection for an SL channel, e.g. PSSCH, and Mode 2 resource allocation, etc., can be handled properly when a dedicated resource pool is (pre) configured. It can also avoid that the resources indicated in the issued/selected SL grant is within the dedicated resource pool while the SLCH with the highest priority carries another type of message that is not allowed to use the resources in the dedicated resource pool for transmission. As such, performance degradation due to the introduction of the dedicated resource pool can be mitigated.

### BRIEF DESCRIPTION OF THE DRAWINGS

A more complete understanding of the present embodiments, and the attendant advantages and features thereof, will be more readily understood by reference to the following detailed description when considered in conjunction with the accompanying drawings wherein:

FIG. 1 schematically shows a method at a UE for SL transmission with a dedicated resource pool according to an exemplary embodiment of the present disclosure;

FIG. 2 schematically shows a method at a network node for SL transmission with a dedicated resource pool according to an exemplary embodiment of the present disclosure;

FIG. 3 schematically shows a structural block diagram of a UE according to an exemplary embodiment of the present disclosure;

FIG. 4 schematically shows a structural block diagram of a UE according to another exemplary embodiment of the present disclosure;

FIG. 5 schematically shows a structural block diagram of a network node according to an exemplary embodiment of the present disclosure;

FIG. 6 schematically shows a structural block diagram of a network node according to another exemplary embodiment of the present disclosure;

FIG. 7 schematically illustrates a schematic diagram of an exemplary network architecture illustrating a communication system connected via an intermediate network to a host computer according to the principles in the present disclosure;

FIG. 8 schematically illustrates a generalized block diagram of a host computer communicating via a network node with a UE over an at least partially wireless connection according to some embodiments of the present disclosure;

FIG. 9 schematically illustrates a flowchart illustrating exemplary methods implemented in a communication system including a host computer, a network node and a UE for executing a client application at a UE according to some embodiments of the present disclosure;

FIG. 10 schematically illustrates a flowchart illustrating exemplary methods implemented in a communication system including a host computer, a network node and a UE for receiving user data at a UE according to some embodiments of the present disclosure;

FIG. 11 schematically illustrates a flowchart illustrating exemplary methods implemented in a communication system including a host computer, a network node and a UE for receiving user data from the UE at a host computer according to some embodiments of the present disclosure; and

FIG. 12 schematically illustrates a flowchart illustrating exemplary methods implemented in a communication system including a host computer, a network node and a UE for receiving user data at a host computer according to some embodiments of the present disclosure.

### DETAILED DESCRIPTION

Hereinafter, the principle and spirit of the present disclosure will be described with reference to illustrative embodiments. Some of the embodiments contemplated herein will now be described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art.

Those skilled in the art will appreciate that the term “exemplary” is used herein to mean “illustrative,” or “serving as an example.” and is not intended to imply that a particular embodiment is preferred over another or that a particular feature is essential. Likewise, the terms “first” and “second,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises.” “comprising.” “includes” and/or “including” when used herein, specify the presence of stated features, integers, steps, operations, elements, and/or components, but do not preclude the presence or addition of one or more other features, integers, steps, operations, elements, components, and/or groups thereof.

In embodiments described herein, the joining term, “in communication with” and the like, may be used to indicate electrical or data communication, which may be accomplished by physical contact, induction, electromagnetic radiation, radio signaling, infrared signaling or optical signaling, for example. One having ordinary skill in the art will appreciate that multiple components may interoperate and modifications and variations are possible of achieving the electrical and data communication.

In some embodiments described herein, the term “coupled.” “connected.” and the like, may be used herein to indicate a connection, although not necessarily directly, and may include wired and/or wireless connections.

The term “network node” used herein can be any kind of network node comprised in a radio network which may further comprise any of base station (BS), radio base station, base transceiver station (BTS), base station controller (BSC), radio network controller (RNC), g Node B (gNB), evolved Node B (eNB or eNodeB), Node B, multi-standard radio (MSR) radio node such as MSR BS, multi-cell/multicast coordination entity (MCE), integrated access and backhaul (IAB) node, relay node, donor node controlling relay, radio access point (AP), transmission points, transmission nodes, Remote Radio Unit (RRU) Remote Radio Head (RRH), a core network node (e.g., mobile management entity (MME), self-organizing network (SON) node, a coordinating node, positioning node. MDT node, etc.), an external node (e.g., 3rd party node, a node external to the current network), nodes in distributed antenna system (DAS), a spectrum access system (SAS) node, an element management system (EMS), etc. The network node may also comprise test equipment. The term “radio node” used herein may be used to also denote a wireless device such as a wireless device or a radio network node.

In some embodiments, the non-limiting terms wireless device or UE are used interchangeably. The UE herein can be any type of wireless device capable of communicating with a network node or another wireless device over radio signals, such as wireless device. The UE may also be a radio communication device, target device, D2D wireless device, machine type wireless device or wireless device capable of machine to machine communication (M2M), low-cost and/or low-complexity wireless device, a sensor equipped with wireless device, Tablet, mobile terminals, smart phone, laptop embedded equipped (LEE), laptop mounted equipment (LME), USB dongles, Customer Premises Equipment (CPE), an Internet of Things (IoT) device, or a Narrowband IoT (NB-IoT) device, etc.

Also, in some embodiments the generic term “radio network node” is used. It can be any kind of a radio network node which may comprise any of base station, radio base station, base transceiver station, base station controller, network controller, RNC, evolved Node B (eNB), Node B, gNB, Multi-cell/multicast Coordination Entity (MCE), IAB node, relay node, access point, radio access point, Remote Radio Unit (RRU) Remote Radio Head (RRH).

Note that although terminology from one particular wireless system, such as, for example, 3GPP LTE and/or New Radio (NR), may be used in this disclosure, this should not be seen as limiting the scope of the present disclosure to only the aforementioned system. Other wireless systems, including without limitation Wide Band Code Division Multiple Access (WCDMA), Worldwide Interoperability for Microwave Access (WiMax), Ultra Mobile Broadband (UMB) and Global System for Mobile Communications (GSM), may also benefit from exploiting the ideas covered within this disclosure.

Note further, that functions described herein as being performed by a UE or a network node may be distributed over a plurality of UEs and/or network nodes. In other words, it is contemplated that the functions of the network node and UE described herein are not limited to performance by a single physical device and, in fact, can be distributed among several physical devices.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

The embodiments of the present disclosure can be applied to e.g., NR Radio Access Technology (RAT), LTE RAT and any other RAT enabling direct communication between two (or more) nearby devices.

Hereinafter, some concepts related to the present disclosure will be described in detail.

### Sidelink Transmissions In NR

As enhancements of the ProSe specified for LTE, four new enhancements are particularly introduced in the NR sidelink transmissions as follows:
Support for unicast and groupcast transmissions are added in NR sidelink. For unicast and groupcast, the Physical Sidelink Feedback Channel (PSFCH) is introduced for a receiver UE to reply the decoding status to a transmitter UE.
Grant-free transmissions, which are adopted in NR uplink transmissions, are also provided in NR sidelink transmissions, to improve the latency performance.
To alleviate resource collisions among different sidelink transmissions launched by different UEs, it enhances channel sensing and resource selection procedures, which also lead to a new design of Physical Sidelink Common Control Channel (PSCCH).
To achieve a high connection density, congestion control and thus the Quality-of-Service (QOS) management is supported in NR sidelink transmissions.

To enable the above enhancements, new physical channels and reference signals are introduced in NR (some are available in LTE before.):
PSSCH (Physical Sidelink Shared Channel, SL version of PDSCH): The PSSCH is transmitted by a sidelink transmitter UE, which conveys sidelink transmission data, System Information Blocks (SIBs) for Radio Resource Control (RRC) configuration, and a part of the Sidelink Control Information (SCI).
PSFCH (Physical Sidelink Feedback Channel, SL version of PUCCH): The PSFCH is transmitted by a sidelink receiver UE for unicast and groupcast, which conveys 1 bit information over 1 Radio Block (RB) for the Hybrid Automatic Repeat Request (HARQ) Acknowledgement (ACK) and the Negative ACK (NACK). In addition, Channel State Information (CSI) is carried in the Medium Access Control (MAC) Control Element (CE) over the PSSCH instead of the PSFCH.
PSCCH (Physical Sidelink Common Control Channel, SL version of PDCCH): When the traffic to be sent to a receiver UE arrives at a transmitter UE, a transmitter UE should first send the PSCCH, which conveys a part of SCI (SL version of DCI) to be decoded by any UE for the channel sensing purpose, including the reserved time-frequency resources for transmissions, Demodulation Reference Signal (DMRS) pattern and antenna port, etc.
Sidelink Primary/Secondary Synchronization Signal (S-PSS/S-SSS): Similar to downlink transmissions in NR, in sidelink transmissions, primary and secondary synchronization signals (called S-PSS and S-SSS, respectively) are supported. Through detecting the S-PSS and S-SSS, a UE is able to identify the Sidelink Synchronization Identity (SSID) from the UE sending the S-PSS/S-SSS. Through detecting the S-PSS/S-SSS, a UE is therefore able to know the characteristics of the UE transmitting the S-PSS/S-SSS. A series of process of acquiring timing and frequency synchronization together with SSIDs of UEs is called initial cell search. Note that the UE sending the S-PSS/S-SSS may not be necessarily involved in sidelink transmissions, and a node (e.g., UE, network node, such as eNB, gNB etc.) sending the S-PSS/S-SSS is called a synchronization source. There are 2 S-PSS sequences and 336 S-SSS sequences forming a total of 672 SSIDs in a cell.
Physical Sidelink Broadcast Channel (PSBCH): The PSBCH is transmitted along with the S-PSS/S-SSS as a synchronization signal/PSBCH block (SSB). The SSB has the same numerology as PSCCH/PSSCH on that carrier, and an SSB should be transmitted within the bandwidth of the configured Bandwidth Part (BWP). The PSBCH conveys information related to synchronization, such as the Direct Frame Number (DFN), indication of the slot and symbol level time resources for sidelink transmissions, in-coverage indicator, etc. The SSB is transmitted periodically at every 160 ms.
DMRS, Phase Tracking-Reference Signal (PT-RS), Channel State Information Reference Signal (CSIRS): These physical reference signals supported by NR downlink/uplink transmissions are also adopted by sidelink transmissions. Similarly, the PT-RS is only applicable for FR2 transmission.

Another new feature is the two-stage SCI. This is a version of the DCI for SL. Unlike the DCI, only part (first stage) of the SCI is sent on the PSCCH. This part is used for channel sensing purposes (including the reserved time-frequency resources for transmissions, DMRS pattern and antenna port, etc.) and can be read by all UEs while the remaining (second stage) scheduling and control information such as a 8-bits source identity (ID) and a 16-bits destination ID, New Data Indicator (NDI), Redundancy Version (RV) and Hybrid Automatic Repeat Request (HARQ) process ID is sent on the PSSCH to be decoded by the receiver UE.

Similar as for ProSe in LTE, NR sidelink transmissions have the following two modes of resource allocations:
Mode 1: Sidelink resources are scheduled by a network node, such as gNB.
Mode 2: The UE autonomously selects sidelink resources from a (pre-) configured sidelink resource pool(s) based on the channel sensing mechanism.

For the in-coverage UE, a network node, such as a gNB, can be configured to adopt Mode 1 or Mode 2. For the out-of-coverage UE, only Mode 2 can be adopted.

As in LTE, scheduling over the sidelink in NR is done in different ways for Mode 1 and Mode 2.

Mode 1 supports the following two kinds of grants:
Dynamic grant: When the traffic to be sent over sidelink arrives at a transmitter UE, this UE should launch the four-message exchange procedure to request sidelink resources from a network node (Scheduling Request (SR) on UL, grant, Buffer Status Report (BSR) on UL, grant for data on SL sent to UE). During the resource request procedure, a network node, such as a gNB, may allocate a Sidelink Radio Network Temporary Identifier (SL-RNTI) to the transmitter UE. If this sidelink resource request is granted by a network node, such as a gNB, then the gNB indicates the resource allocation for the PSCCH and the PSSCH in the DCI conveyed by PDCCH with Cyclic Redundancy Check (CRC) scrambled with the SL-RNTI. When a transmitter UE receives such DCI, the transmitter UE can obtain the grant only if the scrambled CRC of the DCI can be successfully solved by the assigned SL-RNTI. The transmitter UE then indicates the time-frequency resources and the transmission scheme of the allocated PSSCH in the PSCCH, and launches the PSCCH and the PSSCH on the allocated resources for sidelink transmissions. When a grant is obtained from a network node, such as a gNB, the transmitter UE can only transmit a single TB. As a result, this kind of grant is suitable for traffic with a loose latency requirement.
Configured grant: For the traffic with a strict latency requirement, performing the four-message exchange procedure to request sidelink resources may induce unacceptable latency. In this case, prior to the traffic arrival, a transmitter UE may perform the four-message exchange procedure and request a set of resources. If a grant can be obtained from a network node, such as a gNB, then the requested resources are reserved in a periodic manner. Upon traffic arriving at the transmitter UE, this transmitter UE can launch the PSCCH and the PSSCH on the upcoming resource occasion. In fact, this kind of grant is also known as grant-free transmissions.

The configured grant may include:
configured grant Type 1, which is configured by RRC, e.g. ConfiguredGrantConfig; and
configured grant Type 2, activation or deactivation of which is indicated in DCI.

In both dynamic grant and configured grant, a sidelink receiver UE cannot receive the DCI (since it is addressed to the transmitter UE), and therefore the receiver UE should perform blind decoding to identify the presence of PSCCH, and find the resources for the PSSCH through the SCI.

When the transmitter UE launches the PSCCH, CRC is also inserted in the SCI without any scrambling.

In the Mode 2 resource allocation, when traffic arrives at a transmitter UE, this transmitter UE should autonomously select resources for the PSCCH and the PSSCH. To further minimize the latency of the feedback HARQ ACK/NACK transmissions and subsequently retransmissions, the transmitter UE may also reserve resources for PSCCH/PSSCH for retransmissions. To further enhance the probability of successful TB decoding at one shot and thus suppress the probability to perform retransmissions, the transmitter UE may repeat the TB transmission along with the initial TB transmission. This mechanism is also known as blind retransmission. As a result, when traffic arrives at the transmitter UE, this transmitter UE should select resources for at least one of the following transmissions:
1) The PSSCH associated with the PSCCH for initial transmission and blind retransmissions; and
2) The PSSCH associated with the PSCCH for retransmissions.

Since each transmitter UE in sidelink transmissions should autonomously select resources for above transmissions, how to prevent different transmitter UEs from selecting the same resources turns out to be a critical issue in Mode 2. A particular resource selection procedure is therefore imposed to Mode 2 based on channel sensing. When performing the channel sensing, the UE decodes SCI transmitted on PSCCH from the surrounding UEs, and could know the resources on which the associated PSSCH is transmitted by these surrounding UEs, and also know the highest priority of the Sidelink Logical Channel(s) (SLCH(s)) in the MAC Protocol Data Unit (PDU) transmitted over PSSCH, which is indicated in the priority field in SCI from the surrounding UEs. The UE also measures PSSCH Reference Signal Received Power (RSRP) and compares it to a threshold. The resource is regarded unoccupied and available for transmission if the measured PSSCH RSRP of the resource is lower than the threshold. The threshold is set by taking the priorities of both the sensing UE and the sensed UE(s) into account, in a way that the threshold is set higher if the sensing UE has a higher priority than the sensed UE(s), so that the resource is more likely regarded as unoccupied and available for the sensing UE's transmission.

### Transmission (Tx) Parameters for PSSCH

For resource selection, Channel Busy Ratio (CBR) measurement can be considered by the UE, so that the transmission using the selected resources is expected to occupy the channel not beyond the configured congestion threshold.

As described in Clause 5.22.1.1 of 3GPP TS 38.321 V16.4.0, which is incorporated herein in its entirety by reference, when performing SL transmission on PSSCH, the MAC entity should:
select the number of HARQ retransmissions from the allowed numbers that are configured by RRC in sl-MaxTxTransNumPSSCH included in sl-PSSCHI-TxConfigList and, if configured by RRC, overlapped in sl-MaxTxTransNumPSSCH indicated in sl-CBR-PriorityTxConfigList for the highest priority of the logical channel(s) allowed on the carrier and the CBR measured by lower layers if CBR measurement results are available, or overlapped in sl-MaxTxTransNumPSSCH indicated in the corresponding sl-defaultTxConfigIndex configured by RRC if CBR measurement results are not available.
select an amount of frequency resources within the range that is configured by RRC between sl-MinSubChannelNumPSSCH and sl-MaxSubchannelNumPSSCH included in sl-PSSCH-TxConfigList and, if configured by RRC, overlapped between MinSubChannelNumPSSCH and MaxSubchannelNumPSSCH indicated in sl-CBR-PriorityTxConfigList for the highest priority of the logical channel(s) allowed on the carrier and the CBR measured by lower layers if CBR measurement results are available, or overlapped between MinSubChannelNumPSSCHI and MaxSubchannelNumPSSCHI indicated in the corresponding sl-defaultTxConfigIndex configured by RRC if CBR measurement results are not available;
select a Modulation and Coding Scheme (MCS) which is, if configured, within the range that is configured by RRC between sl-MinMCS-PSSCH and sl-MaxMCS-PSSCH included in sl-PSSCH-TxConfigList and, if configured by RRC, overlapped between sl-MinMCS-PSSCH and sl-MaxMCS-PSSCH indicated in sl-CBR-PriorityTxConfigList for the highest priority of the sidelink logical channel(s) in the MAC PDU and the CBR measured by lower layers if CBR measurement results are available, or overlapped between sl-MinMCS-PSSCH and sl-MaxMCS-PSSCH indicated in the corresponding sl-defaultTxConfigIndex configured by RRC if CBR measurement results are not available.

### UE-to-Network Relay

The UE-to-Network Relay (U2N) is being introduced in Rel-17, which enables coverage extension and power saving for the Remote UE. A RAN2 work item on sidelink relay (RP-210893, which is incorporated herein in its entirety by reference) is ongoing, of which the objective is to specify solutions to enable single-hop, sidelink-based, layer 2 (L2) and layer 3 (L3) based U2N relaying. The objectives on aspects common to both L2 and L3 U2N relay includes:
Specifying mechanisms for U2N relay discovery and (re) selection for L3 and L2 relaying; and
Specifying mechanisms for Relay and Remote UE authorization for L3 and L2 relaying.

### UE-to-Network Relay Discovery

UE-to-Network Relay Discovery is applicable to both Layer-3 and Layer-2 UE-to-Network relay discovery for both public safety services and commercial services. The Remote UE and the UE-to-Network Relay UE use pre-configured or provisioned information for the relay discovery procedures.

Both Model A and Model B discovery are supported, in which:
Model A uses a single discovery protocol message (Announcement), which can only be sent by the UE-to-Network Relay UE; and
Model B uses two discovery protocol messages (Solicitation and Response), which can only be initiated by the Remote UE.

The mapping of ProSe services (i.e. Application IDs) to Destination Layer-2 ID(s) for sending/receiving initial signaling of discovery messages is provisioned to the UE by e.g. core NW, while the UE self-selects a Source Layer-2 ID for ProSe Discovery.

### Sidelink LCP

The sidelink LCP procedure is applied when a new sidelink transmission is performed. Each SLCH has an associated priority which is ProSe Per-Packet Priority (PPPP) in LTE and optionally an associated ProSe Per-Packet Reliability (PPPR). In NR, the associated priority and reliability may be derived from the QoS profile of the sidelink radio bearer.

When the MAC entity allocates resources to SLCHs (which are interchangeable with ‘sidelink LCHs’) having data available for transmission, it should first select a destination, e.g., a Layer2 destination, to which the transmission should be performed, based on the highest priority of all the SLCHs belonging to each destination, only SLCHs with available data are considered, and the destination having the highest priority is selected. After this, SLCHs belonging to the selected destination are served in a decreasing order of priority, until either the data for the SLCH(s) or the SL grant is exhausted, whichever comes first.

If there are simultaneous UL and sidelink transmission, prioritization between UL and sidelink transmission is needed. In NR, if the UE cannot support simultaneous UL and sidelink transmission, SL transmission can only be performed if UL priority is low (i.e. the highest priority of the UL logical channel(s) in the MAC PDU is higher than ul-PrioritizationThres) and SL priority is high (i.e. the highest priority of SL logical channel(s) or a SL MAC CE in the MAC PDU is lower than sl-PrioritizationThres).

In RAN2 #114, RAN2 has made the following agreement regarding a discovery resource pool.

Proposal 6 [discussion]: RAN2 agrees that a dedicated discovery resource pool is supported besides a shared resource pool configuration, and whether it is configured is based on network implementation. And PHY layer parameters and design shall reuse the Rel-16 legacy resource pool design (including resource allocation design).

RAN2 agrees that the UE selection between a dedicated resource pool and a shared resource pool can be discussed as a stage 3 issue after RAN #92-c.

Based on the above agreement, a dedicated resource pool is supported for a specific type of SL message, e.g., a discovery message or traffic, in addition to the shared resource pool.

This will cause problems in several procedures in which an SLCH priority needs to be considered, such as sidelink LCP, prioritization between UL transmission and SL transmission, transmission parameters selection for an SL channel, e.g. PSSCH, and Mode 2 resource allocation, etc. Currently, the highest priority of all the SLCHs belonging to a destination or allowed on the carrier is considered, this obviously does not work if the resources indicated in the issued/selected SL grant are within a resource pool dedicated for transmission of a specific type of SL message (i.e., which is allowed to use resources in the dedicated resource pool for transmission), e.g., a discovery message, as it makes no sense to consider SLCHs carrying another type of SL message that is not allowed to use resources in the dedicated resource pool for transmission, e.g., traffic, other than a discovery message. Besides, the performance will suffer in a case where the resources indicated in the issued/selected SL grant are within the resource pool dedicated for transmission of e.g. a discovery message while the highest priority SLCH carries e.g., traffic other than a discovery message.

Moreover, when both dedicated pool and shard pool are configured, how to perform pool selection is also a problem.

Therefore, it is necessary to study the above problems and develop corresponding solutions.

As previously described, the link or radio link over which signals are transmitted between at least two UEs for D2D operations is called herein as a sidelink. The signals transmitted between the UEs for D2D operation are called herein as SL signals. The term SL may also interchangeably be called as D2D link, V2X link, ProSe link, peer-to-peer link, PC5 link etc. The SL signals may also interchangeably be called as V2X signals, D2D signals, ProSe signals, PC5 signals, peer-to-peer signals etc.

The embodiments of the present disclosure are in general applicable to scenarios with a dedicated resource pool that is dedicated for transmission of a specific type of message (i.e., which is allowed to use resources in the dedicated resource pool for transmission). The dedicated resource pool may be configured by the network node (e.g., eNB, gNB etc.) or preconfigured in the UE. The specific type of message may be e.g., traffic, or a discovery message, such as a direct ProSe discovery message, a relay discovery message, etc.

The basic ideas of the present disclosure mainly consist in that:
when resources indicated in a received/selected SL grant belong to a dedicated resource pool for transmission of a specific type of SL message, e.g. a discovery message or traffic, the highest priority of SLCHs used to carry or carrying the specific type of SL message is used in sidelink LCP (including destination selection and prioritization among SLCHs associated with the selected destination), prioritization between UL transmission and SL transmission, and transmission parameters selection for an SL channel, e.g. PSSCH;
when performing sensing in a dedicated resource pool for transmission of the specific type of SL message, e.g. a discovery message or traffic, the highest priority of SLCHs carrying the specific type of SL message is used to determine the sensing threshold;
when performing preemption in a dedicated resource pool for transmission of the specific type of SL message, e.g. a discovery message or traffic, the highest priority of SLCHs carrying the specific type of SL message is used to determine whether a resource in the dedicated resource pool can be preempted;
criteria for pool selection are proposed when both a shared resource pool and a dedicated resource pool are configured by the network node, or preconfigured in the UE; and
in a case where the highest priority of SLCH(s) carrying a specific type of message that is allowed to use resources in a dedicated resource pool for transmission is lower than the highest priority of SLCH(s) carrying another type of message that is not allowed to use resources in the dedicated resource pool for transmission, e.g., other traffic, or there is available for transmission only the other type of message that is not allowed to use resources in the dedicated resource pool for transmission, and the resources indicated in all the available SL grant(s) are within the dedicated resource pool, a Mode 1 UE may send an SI SR/BSR to the network node to request (additional) SL resources.

Hereinafter, the embodiments of the present disclosure will be described by taking as an example one dedicated resource pool for transmission of a specific type of SL message (also called a “first type of SL message” herein, which is allowed to use resources in the dedicated resource pool for transmission). However, it should be understood that the embodiments of the present disclosure may also be applied to scenarios with a plurality of dedicated resource pools, each of which is dedicated to transmission of at least one type of SL message.

Hereinafter, a method 100 at a UE for SI transmission with a dedicated resource pool according to an exemplary embodiment of the present disclosure will be described with reference to FIG. 1. It should be understood that the UE is an SL capable UE.

The dedicated resource pool may be configured by the network node or preconfigured in the UE (and is thus used).

Alternatively, a dedicated resource pool and a non-dedicated resource pool (e.g., a shared resource pool) may be configured by the network node or preconfigured in the UE, and the dedicated resource pool may be selected by the network node or the UE, which will be described later.

As shown in FIG. 1, the method 100 may include at least steps S101 and S103. The steps S101 and S103 may be performed in a case where the UE has the first type of SL message available for transmission.

In an exemplary embodiment, in which the dedicated resource pool is (pre-) configured and is thus used, in step S101, the UE may obtain an SL grant. The SL grant indicates resources belonging to a dedicated resource pool for transmission of a first type of SL message. With the definition of the dedicated resource pool, i.e., dedicated for transmission of a specific type of message, it may be determined that the specific type of message is allowed to use resources in the dedicated resource pool for transmission.

Herein, “obtaining” means either receiving from another node, such as a network node, or generating by the UE, or preconfigured in the UE, unless indicated otherwise.

In an exemplary embodiment for Mode 1 resource allocation, the SL grant may be obtained by the UE receiving the SL grant from the network node. In this case, the SL grant may be a dynamic SL grant or a configured SL grant.

In another exemplary embodiment for Mode 2 resource allocation, the SL grant may be obtained by the UE generating the SL grant based on the resources selected from the dedicated resource pool for transmission of the first type of SL message.

Upon obtaining the SL grant, the UE may perform actions related to the transmission of the first type of SL message on at least a part of the resources indicated in the SL grant in step $103, by taking into consideration priorities of SLCHs used to carry the first type of SL message.

In an exemplary embodiment, the step S103 may include a sidelink LCP procedure (which includes destination selection and prioritization among SLCHs associated with the selected destination), in which
in a case where the UE has the first type of SL message available for transmission, the UE may selects a destination (e.g. associated to one of unicast, groupcast and broadcast) from a plurality of destinations to which the transmission of the first type of SL message is to be performed, based on a highest priority of SLCHs used to carry the first type of SL message that are associated with each of the plurality of destinations, wherein the selected destination has an SLCH with the highest priority; and assigning the resources indicated in the SL grant to one or more SLCHs used to carry the first type of SL message that are associated with the selected destination, for the transmission of the first type of SL message, based on the priorities of the one or more SLCHs used to carry the first type of SL message that are associated with the selected destination.

The SLCHs from which the sidelink LCP procedure is performed to select the SLCH with the highest priority may satisfy all of the following conditions, if any, for the SL grant, for example,
there is available for transmission the first type of SL message that is allowed to use resources in the dedicated resource pool for transmission;
SBj>0, in a case where there is any SLCH having SBj>0;
sl-configuredGrantType1Allowed, if configured, is set to true in a case where the SL grant is a Configured Grant Type 1;
sl-AllowedCG-List, if configured, includes the configured grant index associated to the SL grant;
sl-HARQ-FeedbackEnabled is set to disabled, if PSFCH is not configured for the SL grant associated to the SCI.

It should be understood that the above conditions are only exemplary for illustration, without any limitation. The present disclosure is equally applicable when any additional condition(s) is introduced into the sidelink LCP procedure to select Destination and logical channels in the future.

It also should be understood that one destination is selected in this exemplary embodiment, but the present disclosure is not limited to this. The UE may select a plurality of destinations in decreasing order of priority, according to the highest priority of SLCHs used to carry the first type of SL message that are associated with each destination.

Compared to the existing sidelink LCP procedure as previously described in Background, the difference in the destination selection procedure consists in that the UE only selects destination(s) which has one or more SLCHs used to carry the first type of message that is allowed to use resources in the dedicated resource pool for transmission, and only considers priority of SLCH(s) used to carry the first type of message that is allowed to use resources in the dedicated resource pool for transmission during destination selection.

In an exemplary embodiment, the step S103 may include a prioritization procedure between UL transmission and SL transmission. For example, in some time instance, there are UL messages needed to be transmitted when the UE is performing the transmission of the first type of message, or vice versa.

In a case where prioritization between UL transmission and SL transmission is needed for the UE, the UE may perform prioritization based on the highest priority of the one or more SLCHs carrying or used to carry the first type of SL message and the highest priority of one or more LCHs carrying or used to carry UL messages; and perform transmission of the UL messages if the UL transmission is prioritized, otherwise, perform the transmission of the first type of SL message. Throughout the description, “SLCH/LCH carrying” means that the SLCH/LCH is carrying the corresponding message(s), and “SLCH/LCH used to carry” means that the UE has the corresponding message(s) available for transmission and the corresponding message(s) is to be transmitted on the SLCH/LCH.

In particular, the UE may perform the transmission of the first type of SL message, if the highest priority of the one or more SLCHs carrying the first type of SL message is smaller than an SL prioritization threshold (e.g., sl-PrioritizationThres), while the highest priority of the one or more LCHs carrying or used to carry the UL message is larger than an UL prioritization threshold (e.g., ul-PrioritizationThres). The UE may perform the transmission of the UL messages, if the highest priority of the one or more SLCHs carrying or used to carry the first type of SL message is larger than an SL prioritization threshold, or the highest priority of the one or more LCHs carrying or used to carry the type of UL message is smaller than an UL prioritization threshold.

The SL prioritization threshold may be configured by the network node or preconfigured in the UE, which may be a value (pre-) configured common to all types of SL messages.

Alternatively, a specific value for the SL prioritization threshold may be configured by the network node or preconfigured in the UE as a specific SL prioritization threshold (e.g., named as sl-DiscoveryPrioritizationThres), which is applied when the resources indicated by the SL grant belong to the dedicated resource pool.

In an exemplary embodiment, the step S103 may include: the UE building an SL MAC PDU that only includes the one or more SLCHs used to carry the first type of SL message.

As previously discussed, there may be a plurality of the first types of SL messages that are allowed to use the resources in the dedicated resource pool for transmission. In this case, the one or more SLCHs used to carry the plurality of the first types of SL messages may be multiplexed in the SL MAC PDU.

However, SLCH(s) used to carry another type of SL message (also called a “second type of SL message”) that is not allowed to use resources in the dedicated resource pool for transmission cannot be multiplexed in the SI MAC PDU.

In an exemplary embodiment, the method may further include: the UE obtaining configuration on SL transmission parameters, which may be performed in a case where the UE has the first type of SL message available for transmission or in a case where the UE has not had the first type of SL message available for transmission yet.

In a case where the UE obtains (e.g., receives or generates or is preconfigured with, as previously described) configuration on SL transmission parameters, such as sl-CBR-PriorityTxConfigList, the step S103 may include a transmission parameter selection procedure, in which the UE (e.g., the MAC entity of the UE) may select SL transmission parameters for the transmission of the first type of SL message, based on the highest priority of the SLCHs used to carry the first type of SL message. The transmission parameter selection procedure is performed in a case where the UE has the first type of SL message available for transmission.

Compared to the existing transmission parameter selection procedure as previously described in Background, the difference consists in that only the highest priority of the SLCHs used to carry the first type of message that is allowed to use resources in the dedicated resource pool for transmission is considered in this procedure, instead of the highest priority of all the SLCHs including not only the SLCHs used to carry the first type of message, but also the SLCHs used to carry the second type of message that is not allowed to use resources in the dedicated resource pool for transmission.

For example, the UE (e.g., the MAC entity of the UE) may select the number of HARQ retransmissions from the allowed numbers that e.g., are configured by the network node via RRC in sl-MuxTxTransNumPSSCH included in sl-PSSCH-TxConfigList and, if configured, overlapped in sl-MaxTxTransNumPSSCH indicated in sl-CBR-PriorityTxConfigList for the highest priority of the SLCHs allowed on the carrier used to carry the first type of SL message that is allowed to use resources in the dedicated resource pool for transmission and the CBR measured by lower layers if CBR measurement results are available, or overlapped in sl-MaxTxTransNumPSSCH indicated in the corresponding sl-defaultTxConfigIndex configured by RRC if CBR measurement results are not available.

For example, the UE (e.g., the MAC entity of the UE) may select an amount of frequency resources within the range that is configured by the network node via RRC between sl-MinSubChannelNumPSSCHI and sl-MaxSubchannelNumPSSCH included in sl-PSSCH-TxConfigList and, if configured, overlapped between MinSubChannelNumPSSCHI and MaxSubchannelNumPSSCHI indicated in sl-CBR-PriorityTxConfigList for the highest priority of the SLCHs allowed on the carrier used to carry the first type of SL message that is allowed to use resources in the dedicated resource pool for transmission and the CBR measured by lower layers if CBR measurement results are available, or overlapped between MinSubChannelNumPSSCH and MaxSubchannelNumPSSCH indicated in the corresponding sl-defaultTxConfigIndex configured by RRC if CBR measurement results are not available.

For example, the UE (e.g., the MAC entity of the UE) may select a Modulation and Coding Scheme (MCS) which is, if configured, within the range that is configured by the network node via RRC between sl-MinMCS-PSSCH and sl-MaxMCS-PSSCH included in sl-PSSCH-TxConfigList and, if configured, overlapped between sl-MinMCS-PSSCH and sl-Max MCS-PSSCH indicated in sl-CBR-PriorityTxConfigList for the highest priority of the SLCHs in the MAC PDU used to carry the first type of SL message that is allowed to use resources in the dedicated resource pool for transmission and the CBR measured by lower layers if CBR measurement results are available, or overlapped between sl-MinMCS-PSSCH and sl-MaxMCS-PSSCH indicated in the corresponding sl-defaultTxConfigIndex configured by RRC if CBR measurement results are not available.

As previously described, in an exemplary embodiment for Mode 1 resource allocation, the SI grant may be obtained by the UE receiving the SL grant from the network node. The SL grant may be a dynamic SL grant or a configured SL grant.

In this case, the UE may identify whether the resources indicated in the SI grant belong to the dedicated resource pool for the transmission of the first type of SL message based on one of:
a pool ID comprised in DCI for indicating a resource pool associated with the SL grant, in a case where the SL grant is a dynamic SI grant, i.e., the network node signals one or more pool IDs in DCI indicating resource pools associated with the SL grant; and
pool configuration in RRC signaling, in a case where the SL grant is a configured SL grant, wherein the pool configuration is associated to a pool ID for indicating a resource pool, i.e., the network node signals one or more pool IDs in the RRC signaling indicating resource pools associated with the SI grant.

As previously described, in an exemplary embodiment for Mode 2 resource allocation, the SL grant may be obtained by the UE generating the SL grant based on the resources selected from the dedicated resource pool for transmission of the first type of SL message.

In the Mode 2 resource allocation, when the UE has the first type of SL message available for transmission, the UE may autonomously perform resource selection for the transmission based on channel sensing, by taking into consideration the priorities of the SLCHs carrying or used to carry the first type of SL message.

In an exemplary embodiment of resource selection, the UE may decode SCI transmitted on an SL control channel (e.g., PSCCH) from a neighbor UE (e.g., a sensed UE) to know resources on which an associated SL data channel (e.g., PSSCH) is transmitted by the neighbor UE and the highest priority of the SLCH associated with the SL data channel; and determine availability of the resources in the dedicated resource pool on which the SL data channel is transmitted, based on comparison of a measured value of link quality of the SL control channel (which is easily obtained and similar with that of the SL data channel) on the resources with a predetermined threshold of link quality, wherein the predetermined threshold of link quality is set based on the highest priority of the SLCHs carrying or used to carry the first type of SL message. Here, the predetermined threshold of link quality may be set based on the highest priority of the SLCHs carrying the first type of SL message.

In an exemplary embodiment, the method 100 may include the following steps.

The UE may obtain (receive or generate or be preconfigured with, as previously described) configuration on preemption of resources in the dedicated resource pool that are preserved by SCI received from a neighbor UE, for the transmission of the first type of SL message that is allowed to use resources in the dedicated resource pool for transmission, which may be performed in a case where the UE has the first type of SL message available for transmission or in a case where the UE has not had the first type of SL message available for transmission yet.

In the case where the UE has the first type of SL message available for transmission, the UE may compare a highest priority of SLCHs carrying or used to carry the first type of SL message with a priority indicated in the received SCI; and determine to preempt the resources preserved by the received SCI, if the highest priority of the SLCHs carrying or used to carry the first type of SL message is higher than the priority indicated in the received SCI.

As previously described, a dedicated resource pool and a non-dedicated resource pool (e.g., a shared resource pool) may be configured by the network node or preconfigured in the UE. In this case, pool selection between the dedicated resource pool and the shared resource pool is needed.

Here, a certain type of resource pool could/should be selected, which means that e.g., in Mode 1 scheduling, the network node could/should issue a dynamic SL grant or activate a Type 2 configured SL grant that indicates resources in the selected resource pool (in this case, the network node performs pool selection, and indicates to the UE by the SL grant): while for Type 1 configured SL grant, the UE could/should use an SL grant indicating resources in the selected resource pool as long as there are Type 1 configured SL grants indicating resources in the selected resource pool (in this case, the network node may configure a plurality of Type 1 configured SL grants indicating resources in different types of resource pools, and the UE selects which of the Type 1 configured SL grants to be used, the selected Type 1 configured SL grant indicating the selected resource pool). For Mode 2 resource allocation, the UE could/should select available resources from the selected resource pool to generate the SL grant (in this case, the UE performs pool selection).

Regarding the pool selection between the dedicated resource pool and the shared resource pool, for example, a shared resource pool could be selected if the UE has available for transmission different types of SL messages including SL messages that are allowed and are not allowed to use resources in the dedicated resource pool for transmission, while a shared resource pool should be selected if the highest priority of SLCH(s) carrying the first type of SL message is lower than that of SLCH(s) carrying the second type of SL message that is not allowed to use resources in the dedicated resource pool for transmission, or the UE only has available for transmission the second type of SL message that is not allowed to use resources in the dedicated resource pool for transmission.

For another example, if the UE only has available for transmission the first type of SL message, or the highest priority of SLCH(s) carrying the first type of SL message is not lower than that of SLCH(s) carrying the second type of SL message that is not allowed to use resources in the dedicated resource pool for transmission, either a dedicated resource pool or a shared resource pool could be selected.

In an exemplary embodiment, the UE may perform pool selection between the dedicated resource pool and the shared resource pool according to at least one of selection criteria:
the shared resource pool is selected, if the UE has available for transmission both the first type of SL message and the second type of SL message that is not allowed to use the resources in the dedicated resource pool for transmission, or if the UE has available for transmission only the second type of SL message; while the dedicated resource pool is selected if the UE has available for transmission only the first type of SL message;
the shared resource pool is selected if the highest priority of the SLCHs used to carry the first type of SL message is not higher than that of SLCHs used to carry the second type of SL message, while the dedicated resource pool is selected if the highest priority of the SLCHs used to carry the first type of SL message is higher than that of SLCHs used to carry the second type of SL message;
a type of resource pool with a higher priority is selected (the same type of resource pool(s) having the same priority), wherein a resource pool is randomly selected or a resource pool with a lowest congestion (e.g., CBR) is selected if there are a plurality of resources pools belonging to the selected pool type, in a case where different priority values are configured by the network node or preconfigured in the UE respectively for the dedicated resource pool and the shared resource pool;
a type of resource pool is selected according to configuration by the network node or preconfiguration in the UE, in which case a resource pool is randomly selected or a resource pool with a lowest congestion (e.g., CBR) is selected if there are a plurality of resources pools belonging to the selected pool type;
a resource pool with a lower congestion (e.g., a lower measured CBR) is selected, regardless of the type of the pool;
the UE transmits a preference indication on the pool selection to the network node, receives acceptance of the preference indication from the network node, and selects a type of resource pool based on the preference indication;
the UE transmits a preference indication on the pool selection to the network node, receives another preference indication from the network node, and selects a type of resource pool based on the received preference indication;
it is up to implementation of the UE to select which type of resource pool.

In an exemplary embodiment, the preference indication on the pool selection may be carried via at least one of:
RRC signaling, wherein the UE may use an existing RRC signaling message or a new RRC signaling message for transmitting the preference indication;
a MAC CE or MAC subheader, e.g., a new field (e.g., a resource pool index) may be added to the MAC CE; alternatively, a new MAC CE may be defined for signaling the preference indication to the network node; in an example, a new field (e.g., a resource pool index) may be added to the SL BSR MAC CE; alternatively, existing fields in a MAC subheader or in a MAC CE may be repurposed for carrying the preference indication;
a control PDU of a protocol layer, such as Simple Distributed File System (DFS) Access Protocol (SDAP), Packet Data Convergence Protocol (PDCP), Radio Link Control (RLC) or an adaptation layer in case of SL relay;
an L1 signaling carried in a physical channel, wherein the UE may use specific L1 resources to transmit L1 signaling for signaling the preference indication; for example, the UE uses specific SR configuration to transmit an SR for signaling the preference indication, in which case the UE may receive separate SR configurations associated with different types of resource pools respectively (which may be performed in a case where the UE has the first type of SL message available for transmission or in a case where the UE has not had the first type of SL message available for transmission yet), and transmit an SR for signaling the preference indication using specific one of the separate SR configurations, in a case where the UE has the first type of SL message available for transmission;
specific Random Access Channel (RACH) resources, wherein the UE may use specific RACH resources to transmit an RA message for signaling the preference indication, in which case the UE may receive separate RACH resources associated with different types of resource pools respectively (which may be performed in a case where the UE has the first type of SL message available for transmission or in a case where the UE has not had the first type of SL message available for transmission yet), and transmits a RA message for signaling the preference indication using specific one of the separate RACH resources, in a case where the UE has the first type of SL message available for transmission.

As previously described, the dedicated resource pool may be selected after the pool selection procedure.

In an exemplary embodiment, the UE may obtain (e.g., receive, from the network node) configuration on a specific SL Logical Channel Group ‘SLCG’ that at least comprises an SLCH used to carry the first type of SL message, which may be performed in a case where the UE has the first type of SL message available for transmission or in a case where the UE has not had the first type of SL message available for transmission yet. Then, the UE may transmit, to the network node, an SL BSR comprising the configured specific SLCG, in the case where the UE has the first type of SL message available for transmission.

This may e.g., facilitate the network node to distinguish SLCH(s) carrying the first type of SL message that is allowed to use resources in the dedicated resource pool for transmission from SLCH(s) carrying the second type of SL message that is not allowed to use resources in the dedicated resource pool for transmission when receiving SL BSR. Consequently, the network node may know whether the UE has the first type of SL message and/or the second type of SL message to transmit, and the respective highest SLCH priority, based on which the network node may determine which resource pool (e.g., either dedicated or shared resource pool) among all available resource pools shall be selected, and further assign an SL grant to the UE in the selected resource pool.

In an exemplary embodiment, the UE may receive, from the network node, configuration on an SR that is associated with an SLCH and/or SLCG used to carry the first type of SL message, which may be performed in a case where the UE has the first type of SL message available for transmission or in a case where the UE has not had the first type of SL message available for transmission yet. Then, the UE may trigger the configured SR, in the case where the UE has the first type of SL message available for transmission; and transmit the configured SR to the network node.

In an exemplary embodiment, in a case where the highest priority of SLCHs used to carry the first type of SL message is lower than the highest priority of SLCHs used to carry a second type of SL message that is not allowed to use the dedicated resource pool for transmission, or in a case where the UE has available for transmission only a second type of SL message that is not allowed to use the dedicated resource pool for transmission, and the UE has only an available SL grant indicating resources belonging to the dedicated resource pool, the UE may trigger an SR for requesting additional resources for the second type of SL message; and transmit the SR to the network node.

In an exemplary embodiment, after the type of resource pool is selected, the UE may switch to another type of resource pool due to at least one of reasons of:
congestion (e.g., in terms of CBR) in the selected resource pool being higher than a predetermined threshold,
measured transmission performance (e.g., in terms of HARQ NACK ratio) using the selected resource pool become being higher than a threshold,
measured Quality of Service (QOS) metrics (e.g., in terms of packet delay, packet loss, etc.) using the selected resource pool not meeting specific requirements,
services/applications/traffic types that are associated with different resource pools and have available data having changed, or
the UE's battery life having changed.

In an exemplary embodiment, the UE may perform the actions as described previously according to configuration or signaling from the network node, or pre-configuration. Alternatively, this may be captured in the Standards in hard coded fashion.

In an exemplary embodiment, at least one of the configurations as described previously, such as the configuration on SL transmission parameters, the configuration on preemption, the separate SR configurations associated with different types of resource pools respectively, the configuration on the specific SLCG that at least comprises an SLCH used to carry the first type of SL message, the configuration on the SR that is associated with the SLCH and/or SLCG used to carry the first type of SL message are transmitted etc., may be carried via at least one of:
RRC signaling (e.g., Uu RRC),
a MAC CE,
a control PDU of a protocol layer (e.g., SDAP, PDCP, RLC),
an L1 signaling carried in a physical channel (e.g., PDCCH).

In an exemplary embodiment, the UE may perform actions as described previously according to configuration or signaling from another node (e.g., a controlling UE). The signaling between the UE and the node may be carried via at least one of:
RRC signaling (e.g., PC5 RRC),
a MAC CE,
a Control PDU of a protocol layer (e.g., SDAP, PDCP, RLC, or an adaptation layer in case of SL relay),
L1 signaling carried in a physical channel (e.g., PSSCH, PSCCH, PSFCH, etc).

As described previously, an example of the first type of SL message that is allowed to use resources in the dedicated resource pool for transmission may be one of a discovery message and an SL traffic, and an example of the second type of SL message that is not allowed to use resources in the dedicated resource pool for transmission may be another one of a discovery message and an SL traffic.

The SL traffic may include at least one of: SL data, SL signaling, or SL MAC CE etc.

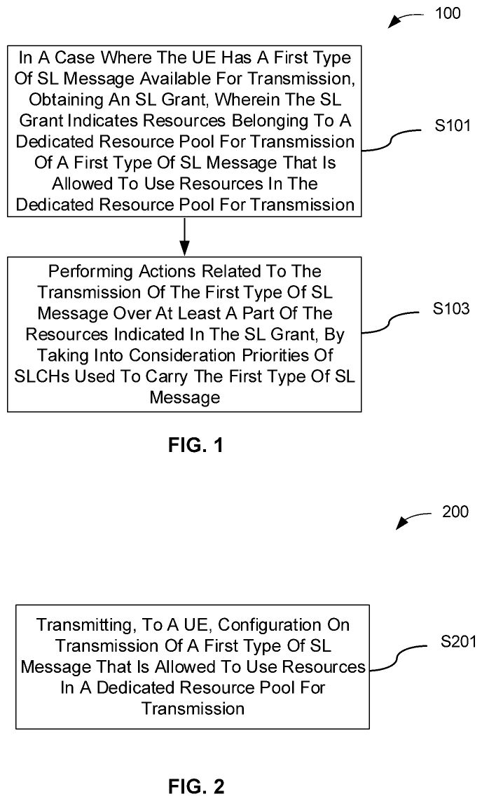

Hereinafter, a method 200 at a network node for SL transmission with a dedicated resource pool according to an exemplary embodiment of the present disclosure will be described with reference to FIG. 2. It should be understood that the method 200 at the network node corresponds to the method 100 at the UE as previously described. Thus, some description of the method 200 may refer to that of method 100, and thus will be omitted for simplicity.

The dedicated resource pool may be configured by the network node (and thus is used).

Alternatively, a dedicated resource pool and a non-dedicated resource pool (e.g., a shared resource pool) may be configured by the network node, and the dedicated resource pool may be selected by the network node, which will be described later.

As shown in FIG. 2, the method 200 may include at least step S201. In step S201, the network node may transmit, to the UE, configuration on transmission of a first type of SL message that is allowed to use resources in the dedicated resource pool that is dedicated for transmission, in a case where the dedicated resource pool is configured by the network node and is thus used. The transmission of the configuration may be performed in a case where the UE has the first type of SL message available for transmission or in a case where the UE has not had the first type of SL message available for transmission yet

In an exemplary embodiment, the network node may transmit an SL grant to the UE. The SL grant may be transmitted in a case where the UE has the first type of SL message available for transmission, and has transmitted the corresponding SR and/or BSR to the network node. This occurs in Mode 1 resource allocation, in which case the SI grant may be a dynamic SL grant or a configured SL grant. The SL grant indicates resources belonging to the dedicated resource pool for the transmission of the first type of SL message.

In an exemplary embodiment, in a case where the network node configures the UE to perform preemption in the dedicated resource pool that are preserved by SCI received from a neighbor UE, for the transmission of the first type of SL message that is allowed to use resources in the dedicated resource pool for transmission, the configuration on transmission of the first type of SL message that is transmitted to the UE in step S201 may include: configuration on preemption in the dedicated resource pool that are preserved by SCI received from a neighbor UE for the transmission of the first type of SL message that is allowed to use resources in the dedicated resource pool for transmission.

As previously described, a dedicated resource pool and a non-dedicated resource pool (e.g., a shared resource pool) may be configured by the network node. In this case, pool selection between the dedicated resource pool and the shared resource pool is needed.

Regarding the pool selection between the dedicated resource pool and the shared resource pool, for example, a shared resource pool could be selected if the UE has available for transmission different types of SL messages including SL messages that are allowed and are not allowed to use resources in the dedicated resource pool for transmission, while a shared resource pool should be selected if the highest priority of SLCH(s) carrying the first type of SL message is lower than that of SLCH(s) carrying the second type of SL message that is not allowed to use resources in the dedicated resource pool for transmission, or the UE only has available for transmission the second type of SL message that is not allowed to use resources in the dedicated resource pool for transmission.

For another example, if the UE only has available for transmission the first type of SL message, or the highest priority of SLCH(s) carrying the first type of SL message is not lower than that of SLCH(s) carrying the second type of SL message that is not allowed to use resources in the dedicated resource pool for transmission, either a dedicated resource pool or a shared resource pool could be selected.

In an exemplary embodiment, the network node may perform pool selection between the dedicated resource pool and the shared resource pool according to at least one of selection criteria:
the shared resource pool is selected, if the UE has available for transmission both the first type of SL message and a second type of SL message that is not allowed to use the resources in the dedicated resource pool for transmission, or if the UE has available for transmission only the second type of SL message; while the dedicated resource pool is selected if the UE has available for transmission only the first type of SL message;
the shared resource pool is selected if the highest priority of the SLCHs used to carry the first type of SL message is not higher than that of SLCHs used to carry the second type of SL message, while the dedicated resource pool is selected if the highest priority of the SLCHs used to carry the first type of SL message is higher than that of SLCHs used to carry the second type of SL message;
a type of resource pool with a higher priority is selected, wherein a resource pool is randomly selected or a resource pool with a lowest congestion is selected if there are a plurality of resources pools belonging to the selected pool type, in a case where different priority values are configured by the network node respectively for the dedicated resource pool and the shared resource pool;
a type of resource pool is selected according to configuration by the network node, in which case a resource pool is randomly selected or a resource pool with a lowest congestion is selected if there are a plurality of resources pools belonging to the selected pool type;
a resource pool with a lower congestion is selected, regardless of the type of the pool;
the network node receives a preference indication from the UE on the pool selection, and selects a type of resource pool taking into consideration the preference indication;
the network node receives the preference indication from the UE on the pool selection, and transmits acceptance of the preference indication to the UE;
it is up to implementation of the network node to select which type of resource pool.

In an exemplary embodiment, the preference indication on the pool selection may be carried via at least one of:
RRC signaling,
a MAC CE,
a control PDU of a protocol layer,
an L1 signaling carried in a physical channel,
specific RACH resources.

In an exemplary embodiment, the configuration on transmission of the first type of SL message that is transmitted to the UE in step S201 may include: separate SR configurations associated with different types of resource pools respectively for the UE to use one of the separate SR configurations to transmit an SR for signaling the preference indication.

As previously described, the dedicated resource pool may be selected after the pool selection procedure.

In an exemplary embodiment, the configuration on transmission of the first type of SL message that is transmitted to the UE in step S201 may include: configuration on a specific SLCG that at least comprises an SLCH used to carry the first type of SL message. In this case, the method 200 may further include: the network node receiving, from the UE, an SL BSR comprising the configured specific SLCG in the case where the UE has the first type of SL message available for transmission.

As previously described, this may e.g., facilitate the network node to distinguish SLCH(s) carrying the first type of SL message that is allowed to use resources in the dedicated resource pool for transmission from SLCH(s) carrying the second type of SL message that is not allowed to use resources in the dedicated resource pool for transmission when receiving SL BSR.

Consequently, the network node may know whether the UE has the first type of SL message and/or the second type of SL message to transmit, and the respective highest SLCH priority, based on which the network node may determine which resource pool (e.g., either dedicated or shared resource pool) among all available resource pools shall be selected, and further assign an SL grant to the UE in the selected resource pool.

In an exemplary embodiment, the configuration on transmission of the first type of SL message that is transmitted to the UE in step S201 may include: configuration on an SR that is associated with an SLCH and/or SLCG used to carry the first type of SL message. In this case, the method 200 may further include: the network node receiving the configured SR from the UE, in the case where the UE has the first type of SL message available for transmission.

In an exemplary embodiment, in a case where the highest priority of SLCHs used to carry the first type of SL message is lower than the highest priority of SLCHs used to carry a second type of SL message that is not allowed to use the dedicated resource pool for transmission, or in a case where the UE has available for transmission only a second type of SL message that is not allowed to use the dedicated resource pool for transmission, and the UE has only an available SL grant indicating resources belonging to the dedicated resource pool, the UE may trigger an SR for requesting additional resources for the second type of SL message; and transmit the SR to the network node. Accordingly, the method 200 may include: the network node receiving, from the UE, an SR for requesting additional resources for the second type of SL message.

In an exemplary embodiment, after the type of resource pool is selected, the network node may switch to another type of resource pool due to at least one of reasons of:
congestion (e.g., in terms of CBR) in the selected resource pool being higher than a predetermined threshold,
measured transmission performance (e.g., in terms of HARQ NACK ratio) using the selected resource pool become being higher than a threshold,
measured QoS metrics (e.g., in terms of packet delay, packet loss, etc.) using the selected resource pool not meeting specific requirements,
services/applications/traffic types that are associated with different resource pools and have available data having changed, or
the UE's battery life having changed.

In an exemplary embodiment, the previously described configuration on transmission of the first type of SL message may be carried via at least one of:
RRC signaling (e.g., Uu RRC),
a MAC CE,
a control PDU of a protocol layer (e.g., SDAP, PDCP, RLC),
an L1 signaling carried in a physical channel (e.g., PDCCH).

As described previously, an example of the first type of SL message that is allowed to use resources in the dedicated resource pool for transmission may be one of a discovery message and an SL traffic, and an example of the second type of SL message that is not allowed to use resources in the dedicated resource pool for transmission may be another one of a discovery message and an SL traffic.

The SL traffic may include at least one of: SL data, SL signaling, or SL MAC CE etc.

In an exemplary embodiment, the first type of SL message may include a plurality of the first types of SL messages.

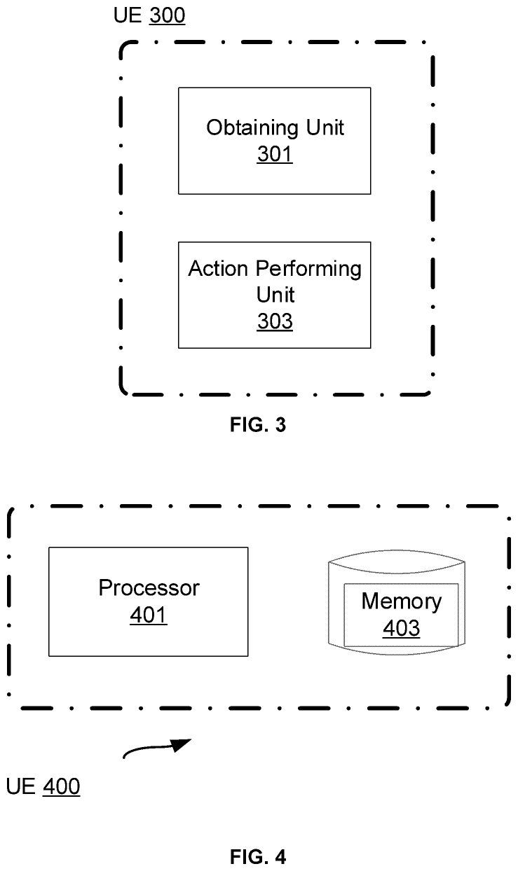

Hereinafter, a structure of a UE according to an exemplary embodiment of the present disclosure will be described with reference to FIG. 3. FIG. 3 schematically shows a block diagram of the UE 300 according to an exemplary embodiment of the present disclosure. The UE 300 in FIG. 3 may perform the method 100 with reference to FIG. 1. Accordingly, some detailed description on the UE 300 may refer to the corresponding description of the method 100 in FIG. 1, and thus will be omitted here for simplicity.

As shown in FIG. 3, the UE 300 may include at least an obtaining unit 301 and an action performing unit 303.

In an exemplary embodiment, in which the UE has the first type of SL message available for transmission, and the dedicated resource pool dedicated for transmission of the first type of SL message is (pre-) configured and is thus used, the obtaining unit 301 may be configured to obtain an SL grant. The SL grant indicates resources belonging to a dedicated resource pool for transmission of a first type of SL message.

In an exemplary embodiment for Mode 1 resource allocation, the SL grant may be obtained by the obtaining unit 301 receiving the SL grant from the network node. In this case, the SL grant may be a dynamic SL grant or a configured SL grant.

In another exemplary embodiment for Mode 2 resource allocation, the SL grant may be obtained by the obtaining unit 301 generating the SL grant based on the resources selected from the dedicated resource pool for transmission of the first type of SL message.

Upon obtaining the SL grant, the action performing unit 303 may be configured to perform actions related to the transmission of the first type of SL message on at least a part of the resources indicated in the SL grant, by taking into consideration priorities of SLCHs used to carry the first type of SL message.

In an exemplary embodiment, the action performing unit 303 may be configured to perform a sidelink LCP procedure (which includes destination selection and prioritization among SLCHs associated with the selected destination), in which in a case where the UE 300 has the first type of SL message available for transmission, a selection unit (not shown) of the UE 300 may selects a destination (e.g. associated to one of unicast, groupcast and broadcast) from a plurality of destinations to which the transmission of the first type of SL message is to be performed, based on a highest priority of SLCHs used to carry the first type of SL message that are associated with each of the plurality of destinations, wherein the selected destination has an SLCH with the highest priority; and assigning the resources indicated in the SL grant to one or more SLCHs used to carry the first type of SL message that are associated with the selected destination, for the transmission of the first type of SL message, based on the priorities of the one or more SLCHs used to carry the first type of SL message that are associated with the selected destination.

The SLCHs from which the sidelink LCP procedure is performed to select the SLCH with the highest priority may satisfy all the following conditions, if any, for the SL grant, for example,
there is available for transmission the first type of SL message that is allowed to use resources in the dedicated resource pool for transmission;
SBj>0, in a case where there is any SLCH having SBj>0;
sl-configuredGrantType1Allowed, if configured, is set to true in a case where the SL grant is a Configured Grant Type 1;
sl-AllowedCG-List, if configured, includes the configured grant index associated to the SL grant;
sl-HARQ-FeedbackEnabled is set to disabled, if PSFCH is not configured for the SL grant associated to the SCI.

It should be understood that the above conditions are only exemplary for illustration, without any limitation. The present disclosure is equally applicable when any additional condition(s) is introduced into the sidelink LCP procedure to select Destination and logical channels in the future.

In an exemplary embodiment, the action performing unit 303 may be configured to perform a prioritization procedure between UL transmission and SL transmission.

In a case where prioritization between UL transmission and SL transmission is needed for the UE, a prioritization unit (not shown) of the UE 300 may be configured to perform prioritization based on the highest priority of the one or more SLCHs carrying or used to carry the first type of SL message and the highest priority of one or more LCHs carrying or used to carry UL messages; and perform transmission of the UL messages if the UL transmission is prioritized, otherwise, perform the transmission of the first type of SL message.

In particular, a transmitting unit (not shown) of the UE 300 may be configured to perform the transmission of the first type of SL message, if the highest priority of the one or more SLCHs carrying the first type of SL message is smaller than an SL prioritization threshold (e.g., sl-PrioritizationThres), while the highest priority of the one or more LCHs carrying or used to carry the UL message is larger than an UL prioritization threshold (e.g., ul-PrioritizationThres). The transmitting unit of the UE 300 may be further configured to perform the transmission of the UL messages, if the highest priority of the one or more SLCHs carrying or used to carry the first type of SL message is larger than an SL prioritization threshold, or the highest priority of the one or more LCHs carrying or used to carry the type of UL message is smaller than an UL prioritization threshold.

The SL prioritization threshold may be configured by the network node or preconfigured in the UE, which may be a value (pre-) configured common to all types of SL messages.

Alternatively, a specific value for the SL prioritization threshold may be configured by the network node or preconfigured in the UE as a specific SL prioritization threshold (e.g., named as sl-DiscoveryPrioritizationThres), which is applied when the resources indicated by the SL grant belong to the dedicated resource pool.

In an exemplary embodiment, the action performing unit 303 may be configured to building an SL MAC PDU that only includes the one or more SLCHs used to carry the first type of SL message.

As previously discussed, there may be a plurality of the first types of SL messages that are allowed to use the resources in the dedicated resource pool for transmission. In this case, the one or more SLCHs used to carry the plurality of the first types of SL messages may be multiplexed in the SL MAC PDU.

However, SLCH(s) used to carry another type of SL message (also called a “second type of SL message”) that is not allowed to use resources in the dedicated resource pool for transmission cannot be multiplexed in the SI MAC PDU.

In an exemplary embodiment, the obtaining unit 301 of the UE 300 may be further configured to obtain configuration on SL transmission parameters, which may be performed in a case where the UE has the first type of SL message available for transmission or in a case where the UE has not had the first type of SL message available for transmission yet.

In a case where the obtaining unit 301 of the UE 300 obtains configuration on SL transmission parameters, such as sl-CBR-PriorityTxConfigList, the action performing unit 303 may be further configured to perform a transmission parameter selection procedure, in which the selection unit of the UE 300 (e.g., of the MAC entity of the UE) may select SL transmission parameters for the transmission of the first type of SL message, based on the highest priority of the SLCHs used to carry the first type of SL message. The transmission parameter selection procedure is performed in a case where the UE has the first type of SL message available for transmission.

As previously described, in an exemplary embodiment for Mode 1 resource allocation, the SI grant may be obtained by the obtaining unit 301 of the UE 300 receiving the SL grant from the network node. The SL grant may be a dynamic SL grant or a configured SI grant.

In this case, the UE 300 may further include an identification unit (not shown), which may be configured to identify whether the resources indicated in the SL grant belong to the dedicated resource pool for the transmission of the first type of SL message based on one of:
a pool ID comprised in DCI for indicating a resource pool associated with the SL grant, in a case where the SL grant is a dynamic SL grant, i.e., the network node signals one or more pool IDs in DCI indicating resource pools associated with the SL grant; and
pool configuration in RRC signaling, in a case where the SL grant is a configured SL grant, wherein the pool configuration is associated to a pool ID for indicating a resource pool, i.e., the network node signals one or more pool IDs in the RRC signaling indicating resource pools associated with the SL grant.

As previously described, in an exemplary embodiment for Mode 2 resource allocation, the SL grant may be obtained by the obtaining unit 301 generating the SL grant based on the resources selected from the dedicated resource pool for transmission of the first type of SL message.

In the Mode 2 resource allocation, when the UE 300 has the first type of SL message available for transmission, the UE 300 may further include a resource selection unit (not shown), which may be configured to autonomously perform resource selection for the transmission based on channel sensing, by taking into consideration the priorities of the SLCHs carrying or used to carry the first type of SL message.

In an exemplary embodiment of resource selection, the resource selection unit of the UE 300 may decode SCI transmitted on an SL control channel (e.g., PSCCH) from a neighbor UE (e.g., a sensed UE) to know resources on which an associated SI data channel (e.g., PSSCH) is transmitted by the neighbor UE and the highest priority of the SLCH associated with the SL data channel; and determine availability of the resources in the dedicated resource pool on which the SL data channel is transmitted, based on comparison of a measured value of link quality of the SL control channel (which is easily obtained and similar with that of the SL data channel) on the resources with a predetermined threshold of link quality, wherein the predetermined threshold of link quality is set based on the highest priority of the SLCHs carrying or used to carry the first type of SL message. Here, the predetermined threshold of link quality may be set based on the highest priority of the SLCHs carrying the first type of SL message.

In an exemplary embodiment, the obtaining unit 301 of the UE 300 may be further configured to obtain configuration on preemption of resources in the dedicated resource pool that are preserved by SCI received from a neighbor UE, for the transmission of the first type of SL message that is allowed to use resources in the dedicated resource pool for transmission, which may be performed in a case where the UE has the first type of SL message available for transmission or in a case where the UE has not had the first type of SL message available for transmission yet.

In the case where the UE has the first type of SL message available for transmission, the resource selection unit may be further configured to compare a highest priority of SLCHs carrying or used to carry the first type of SL message with a priority indicated in the received SCI; and determine to preempt the resources preserved by the received SCI, if the highest priority of the SLCHs carrying or used to carry the first type of SL message is higher than the priority indicated in the received SCI.

As previously described, a dedicated resource pool and a non-dedicated resource pool (e.g., a shared resource pool) may be configured by the network node or preconfigured in the UE. In this case, pool selection between the dedicated resource pool and the shared resource pool is needed.

In an exemplary embodiment, the UE may include a pool selection unit (not shown), which may be configured to perform pool selection between the dedicated resource pool and the shared resource pool according to at least one of selection criteria:
the shared resource pool is selected, if the UE has available for transmission both the first type of SL message and the second type of SL message that is not allowed to use the resources in the dedicated resource pool for transmission, or if the UE has available for transmission only the second type of SL message; while the dedicated resource pool is selected if the UE has available for transmission only the first type of SL message;
the shared resource pool is selected if the highest priority of the SLCHs used to carry the first type of SL message is not higher than that of SLCHs used to carry the second type of SL message, while the dedicated resource pool is selected if the highest priority of the SLCHs used to carry the first type of SL message is higher than that of SLCHs used to carry the second type of SL message;
a type of resource pool with a higher priority is selected (the same type of resource pool(s) having the same priority), wherein a resource pool is randomly selected or a resource pool with a lowest congestion (e.g., CBR) is selected if there are a plurality of resources pools belonging to the selected pool type, in a case where different priority values are configured by the network node or preconfigured in the UE respectively for the dedicated resource pool and the shared resource pool;
a type of resource pool is selected according to configuration by the network node or preconfiguration in the UE, in which case a resource pool is randomly selected or a resource pool with a lowest congestion (e.g., CBR) is selected if there are a plurality of resources pools belonging to the selected pool type;
a resource pool with a lower congestion (e.g., a lower measured CBR) is selected, regardless of the type of the pool;
the transmitting unit of the UE 300 transmits a preference indication on the pool selection to the network node, a receiving unit (not shown) of the UE 300 receives acceptance of the preference indication from the network node, and the pool selection unit of the UE 300 selects a type of resource pool based on the preference indication;
the transmitting unit of the UE 300 transmits a preference indication on the pool selection to the network node, the receiving unit of the UE 300 receives another preference indication from the network node, and the pool selection unit of the UE 300 selects a type of resource pool based on the received preference indication;
it is up to implementation of the UE to select which type of resource pool.

In an exemplary embodiment, the preference indication on the pool selection may be carried via at least one of:
RRC signaling, wherein the transmitting unit of the UE 300 may use an existing RRC signaling message or a new RRC signaling message for transmitting the preference indication;
a MAC CE or MAC subheader, e.g., a new field (e.g., a resource pool index) may be added to the MAC CE; alternatively, a new MAC CE may be defined for signaling the preference indication to the network node; in an example, a new field (e.g., a resource pool index) may be added to the SL BSR MAC CE; alternatively, existing fields in a MAC subheader or in a MAC CE may be repurposed for carrying the preference indication;
a control PDU of a protocol layer, such as SDAP, PDCP, RLC or an adaptation layer in case of SL relay
an L1 signaling carried in a physical channel, wherein the UE may use specific L1 resources to transmit L1 signaling for signaling the preference indication; for example, the UE uses specific SR configuration to transmit an SR for signaling the preference indication, in which case the UE may receive separate SR configurations associated with different types of resource pools respectively (which may be performed in a case where the UE has the first type of SL message available for transmission or in a case where the UE has not had the first type of SL message available for transmission yet), and transmit an SR for signaling the preference indication using specific one of the separate SR configurations, in a case where the UE has the first type of SL message available for transmission;
specific Random Access Channel (RACH) resources, wherein the UE may use specific RACH resources to transmit an RA message for signaling the preference indication, in which case the UE may receive separate RACH resources associated with different types of resource pools respectively (which may be performed in a case where the UE has the first type of SL message available for transmission or in a case where the UE has not had the first type of SL message available for transmission yet), and transmits a RA message for signaling the preference indication using specific one of the separate RACH resources, in a case where the UE has the first type of SL message available for transmission.

As previously described, the dedicated resource pool may be selected by the resource pool selection unit of the UE 300 after the pool selection procedure.

In an exemplary embodiment, the obtaining unit 301 of the UE 300 may obtain configuration on a specific SLCG that at least comprises an SLCH used to carry the first type of SL message, which may be performed in a case where the UE has the first type of SL message available for transmission or in a case where the UE has not had the first type of SL message available for transmission yet. Then, the transmitting unit of the UE may transmit, to the network node, an SL BSR comprising the configured specific SLCG, in the case where the UE has the first type of SL message available for transmission.

In an exemplary embodiment, a receiving unit (not shown) of the UE 300 may receive, from the network node, configuration on an SR that is associated with an SLCH and/or SLCG used to carry the first type of SL message, which may be performed in a case where the UE has the first type of SL message available for transmission or in a case where the UE has not had the first type of SL message available for transmission yet. Then, the transmitting unit of the UE 300 may trigger the configured SR, in the case where the UE has the first type of SL message available for transmission; and transmit the configured SR to the network node.

In an exemplary embodiment, in a case where the highest priority of SLCHs used to carry the first type of SL message is lower than the highest priority of SLCHs used to carry a second type of SL message that is not allowed to use the dedicated resource pool for transmission, or in a case where the UE has available for transmission only a second type of SL message that is not allowed to use the dedicated resource pool for transmission, and the UE has only an available SL grant indicating resources belonging to the dedicated resource pool, the transmitting unit of the UE 300 may trigger an SR for requesting additional resources for the second type of SL message; and transmit the SR to the network node.

In an exemplary embodiment, after the type of resource pool is selected, the pool selection unit of the UE 300 may switch to another type of resource pool due to at least one of reasons of:
congestion (e.g., in terms of CBR) in the selected resource pool being higher than a predetermined threshold,
measured transmission performance (e.g., in terms of HARQ NACK ratio) using the selected resource pool become being higher than a threshold,
measured Quality of Service (QOS) metrics (e.g., in terms of packet delay, packet loss, etc.) using the selected resource pool not meeting specific requirements,
services/applications/traffic types that are associated with different resource pools and have available data having changed, or
the UE's battery life having changed.

In an exemplary embodiment, the action performing unit 303 may perform the actions as described previously according to configuration or signaling from the network node, or pre-configuration. Alternatively, this may be captured in the Standards in hard coded fashion.

In an exemplary embodiment, at least one of the configurations as described previously, such as the configuration on SL transmission parameters, the configuration on preemption, the separate SR configurations associated with different types of resource pools respectively, the configuration on the specific SLCG that at least comprises an SLCH used to carry the first type of SL message, the configuration on the SR that is associated with the SLCH and/or SLCG used to carry the first type of SL message are transmitted etc., may be carried via at least one of:
RRC signaling (e.g., Uu RRC),
a MAC CE,
a control PDU of a protocol layer (e.g., SDAP, PDCP, RLC),
an L1 signaling carried in a physical channel (e.g., PDCCH).

In an exemplary embodiment, the UE may perform actions as described previously according to configuration or signaling from another node (e.g., a controlling UE). The signaling between the UE and the node may be carried via at least one of:
RRC signaling (e.g., PC5 RRC),
a MAC CE,
a Control PDU of a protocol layer (e.g., SDAP, PDCP, RLC, or an adaptation layer in case of SL relay),
L1 signaling carried in a physical channel (e.g., PSSCH, PSCCH, PSFCH, etc).

As described previously, an example of the first type of SL message that is allowed to use resources in the dedicated resource pool for transmission may be one of a discovery message and an SL traffic, and an example of the second type of SL message that is not allowed to use resources in the dedicated resource pool for transmission may be another one of a discovery message and an SL traffic.

The SL traffic may include at least one of: SL data, SL signaling, or SL MAC CE etc.

Hereinafter, a structure of a UE according to another exemplary embodiment of the present disclosure will be described with reference to FIG. 4. FIG. 4 schematically shows a block diagram of a UE 400 according to an exemplary embodiment of the present disclosure. The UE 400 in FIG. 4 may perform the method 100 as described previously with reference to FIG. 1. Accordingly, some detailed description on the UE 400 may refer to the corresponding description of the method 100 in FIG. 1, and thus will be omitted here for simplicity.

As shown in FIG. 4, the UE 400 includes at least one processor 401 and at least one memory 403. The at least one processor 401 includes e.g., any suitable CPU (Central Processing Unit), microcontroller, DSP (Digital Signal Processor), etc., capable of executing computer program instructions. The at least one memory 403 may be any combination of a RAM (Random Access Memory) and a ROM (Read Only Memory). The at least one memory 403 may also include persistent storage, which, for example, can be any single one or combination of magnetic memory, optical memory, or solid state memory or even remotely mounted memory.

The at least one memory 403 stores instructions executable by the at least one processor 401. The instructions, when loaded from the at least one memory 403 and executed on the at least one processor 401, may cause the node 400 to perform the actions. e.g., of the procedures as described earlier in conjunction with FIG. 1, and thus will be omitted here for simplicity.

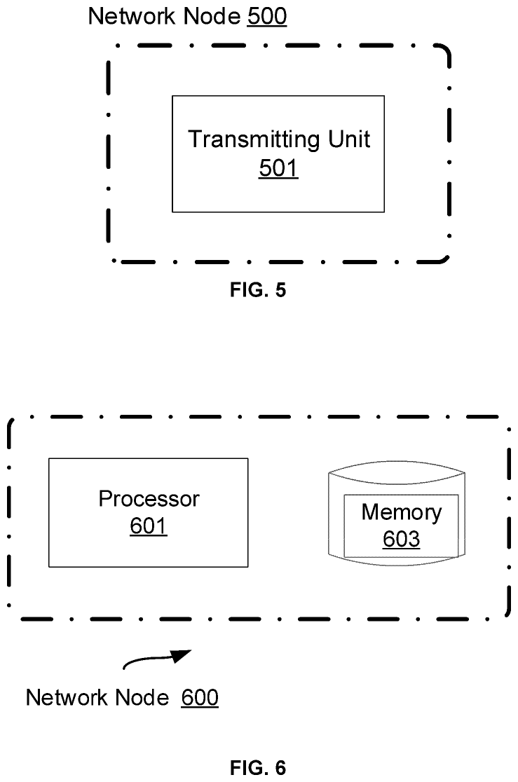

Hereinafter, a structure of a network node according to an exemplary embodiment of the present disclosure will be described with reference to FIG. 5. FIG. 5 schematically shows a block diagram of the network node 500 according to an exemplary embodiment of the present disclosure. The network node 500 in FIG. 5 may perform the method 200 as described previously with reference to FIG. 2. Accordingly, some detailed description on the network node 500 may refer to the corresponding description of the method 200 in FIG. 2, and thus will be omitted here for simplicity.

As shown in FIG. 5, the network node 500 may include at least a transmitting unit 501, which may be configured to transmit, to a UE, configuration on transmission of a first type of SL message that is allowed to use resources in a dedicated resource pool for transmission.

In an exemplary embodiment, the transmitting unit 501 may further be configured to transmit an SL grant to the UE. As previously described, the SL grant is transmitted in a case where the UE has the first type of SL message available for transmission, and transmits the corresponding BR to the network node. This occurs in Mode 1 resource allocation, in which case the SL grant may be a dynamic SL grant or a configured SL grant. The SL grant indicates resources belonging to the dedicated resource pool for the transmission of the first type of SL message.

In an exemplary embodiment, in a case where the network node configures the UE to perform preemption in the dedicated resource pool that are preserved by SCI received from a neighbor UE, for the transmission of the first type of SL message that is allowed to use resources in the dedicated resource pool for transmission, the configuration on transmission of the first type of SL message that is transmitted to the UE in step S201 may include: configuration on preemption in the dedicated resource pool that are preserved by SCI received from a neighbor UE for the transmission of the first type of SL message that is allowed to use resources in the dedicated resource pool for transmission.

In an exemplary embodiment, the network node 500 may further include a configuration unit (not shown), which may be configured to configure the dedicated resource pool.

In an exemplary embodiment, the configuration unit may further be configured to configure the dedicated resource pool and a shared resource pool. In this case, the network node 500 may further include a pool selection unit (not shown), which may be configured to perform pool selection between the dedicated resource pool and the shared resource pool.

In an exemplary embodiment, the pool selection unit may be configured to perform pool selection between the dedicated resource pool and the shared resource pool according to at least one of selection criteria:
the shared resource pool is selected, if the UE has available for transmission both the first type of SL message and a second type of SL message that is not allowed to use the resources in the dedicated resource pool for transmission, or if the UE has available for transmission only the second type of SL message; while the dedicated resource pool is selected if the UE has available for transmission only the first type of SL message;
the shared resource pool is selected if the highest priority of the SLCHs used to carry the first type of SL message is not higher than that of SLCHs used to carry the second type of SL message, while the dedicated resource pool is selected if the highest priority of the SLCHs used to carry the first type of SL message is higher than that of SLCHs used to carry the second type of SL message;
a type of resource pool with a higher priority is selected, wherein a resource pool is randomly selected or a resource pool with a lowest congestion is selected if there are a plurality of resources pools belonging to the selected pool type, in a case where different priority values are configured by the network node respectively for the dedicated resource pool and the shared resource pool;
a type of resource pool is selected according to configuration by the network node, in which case a resource pool is randomly selected or a resource pool with a lowest congestion is selected if there are a plurality of resources pools belonging to the selected pool type;
a resource pool with a lower congestion is selected, regardless of the type of the pool;
a receiving unit (not shown) of the network node 500 receives a preference indication from the UE on the pool selection, and the pool selection unit of the network node 500 selects a type of resource pool taking into consideration the preference indication;
the receiving unit of the network node 500 receives the preference indication from the UE on the pool selection, and the transmitting unit 501 of the network node 500 transmits acceptance of the preference indication to the UE;
it is up to implementation of the network node to select which type of resource pool.

In an exemplary embodiment, the preference indication on the pool selection may be carried via at least one of:
RRC signaling,
a MAC CE,
a control PDU of a protocol layer,
an L1 signaling carried in a physical channel,
specific RACH resources.

In an exemplary embodiment, the configuration on transmission of the first type of SL message that is transmitted to the UE by the transmitting unit 501 may include: separate SR configurations associated with different types of resource pools respectively for the UE to use one of the separate SR configurations to transmit an SR for signaling the preference indication.

As previously described, the dedicated resource pool may be selected by the selection unit after the pool selection procedure.

In an exemplary embodiment, the configuration on transmission of the first type of SL message that is transmitted to the UE by the transmitting unit 501 may include: configuration on a specific SLCG that at least comprises an SLCH used to carry the first type of SL message. In this case, the receiving unit may be further configured to receive, from the UE, an SL BSR comprising the configured specific SLCG in the case where the UE has the first type of SL message available for transmission.

In an exemplary embodiment, the configuration on transmission of the first type of SL message that is transmitted to the UE by the transmitting unit 501 may include: configuration on an SR that is associated with an SLCH and/or SLCG used to carry the first type of SL message. In this case, the receiving unit may be further configured to receive the configured SR from the UE, in the case where the UE has the first type of SL message available for transmission.

In an exemplary embodiment, in a case where the highest priority of SLCHs used to carry the first type of SL message is lower than the highest priority of SLCHs used to carry a second type of SL message that is not allowed to use the dedicated resource pool for transmission, or in a case where the UE has available for transmission only a second type of SL message that is not allowed to use the dedicated resource pool for transmission, and the UE has only an available SL grant indicating resources belonging to the dedicated resource pool, the UE may trigger an SR for requesting additional resources for the second type of SL message; and transmit the SR to the network node. Accordingly, the receiving unit of the network node 500 may be further configured to receive, from the UE, an SR for requesting additional resources for the second type of SL message.

In an exemplary embodiment, after the type of resource pool is selected, the selection unit of the network node 500 may be further configured to switch to another type of resource pool due to at least one of reasons of:
congestion (e.g., in terms of CBR) in the selected resource pool being higher than a predetermined threshold,
measured transmission performance (e.g., in terms of HARQ NACK ratio) using the selected resource pool become being higher than a threshold,
measured QoS metrics (e.g., in terms of packet delay, packet loss, etc.) using the selected resource pool not meeting specific requirements,
services/applications/traffic types that are associated with different resource pools and have available data having changed, or
the UE's battery life having changed.

In an exemplary embodiment, the previously described configuration on transmission of the first type of SL message may be carried via at least one of:
RRC signaling (e.g., Uu RRC),
a MAC CE,
a control PDU of a protocol layer (e.g., SDAP, PDCP, RLC),
an L1 signaling carried in a physical channel (e.g., PDCCH).

As described previously, an example of the first type of SL message that is allowed to use resources in the dedicated resource pool for transmission may be one of a discovery message and an SL traffic, and an example of the second type of SL message that is not allowed to use resources in the dedicated resource pool for transmission may be another one of a discovery message and an SL traffic.

The SL traffic may include at least one of: SL data, SL signaling, or SL MAC CE etc.

In an exemplary embodiment, the first type of SL message may include a plurality of the first types of SL messages.

Hereinafter, a structure of a network node according to another exemplary embodiment of the present disclosure will be described with reference to FIG. 6. FIG. 6 schematically shows a block diagram of a network node 600 according to an exemplary embodiment of the present disclosure. The network node 600 in FIG. 6 may perform the method 200 as described previously with reference to FIG. 2. Accordingly, some detailed description on the network node 600 may refer to the corresponding description of the method 200 in FIG. 2, and thus will be omitted here for simplicity.

As shown in FIG. 6, the network node 600 includes at least one processor 601 and at least one memory 603. The at least one processor 601 includes e.g., any suitable CPU (Central Processing Unit), microcontroller, DSP (Digital Signal Processor), etc., capable of executing computer program instructions. The at least one memory 603 may be any combination of a RAM (Random Access Memory) and a ROM (Read Only Memory). The at least one memory 603 may also include persistent storage, which, for example, can be any single one or combination of magnetic memory, optical memory, or solid state memory or even remotely mounted memory.

The at least one memory 603 stores instructions executable by the at least one processor 601. The instructions, when loaded from the at least one memory 603 and executed on the at least one processor 601, may cause the network node 600 to perform the actions, e.g., of the procedures as described earlier respectively in conjunction with FIG. 2, and thus will be omitted here for simplicity.

The present disclosure also provides at least one computer program product in the form of a non-volatile or volatile memory, e.g., a non-transitory computer readable storage medium, an Electrically Erasable Programmable Read-Only Memory (EEPROM), a flash memory and a hard drive. The computer program product includes a computer program.

The computer program includes: code/computer readable instructions, which when executed by the at least one processor 401 causes the UE 400 to perform the actions, e.g., of the procedures described earlier in conjunction with FIG. 1: or code/computer readable instructions, which when executed by the at least one processor 601 causes the network node 600 to perform the actions, e.g., of the procedures described earlier respectively in conjunction with FIG. 2.

The computer program product may be configured as a computer program code structured in computer program modules. The computer program modules could essentially perform the actions of the flow illustrated in any of FIGS. 1 to 2.

The processor may be a single CPU (Central processing unit), but could also include two or more processing units. For example, the processor may include general purpose microprocessors; instruction set processors and/or related chips sets and/or special purpose microprocessors such as Application Specific Integrated Circuit (ASICs). The processor may also include board memory for caching purposes. The computer program may be carried by a computer program product connected to the processor. The computer program product may include a non-transitory computer readable storage medium on which the computer program is stored. For example, the computer program product may be a flash memory, a Random-access memory (RAM), a Read-Only Memory (ROM), or an EEPROM, and the computer program modules described above could in alternative embodiments be distributed on different computer program products in the form of memories.

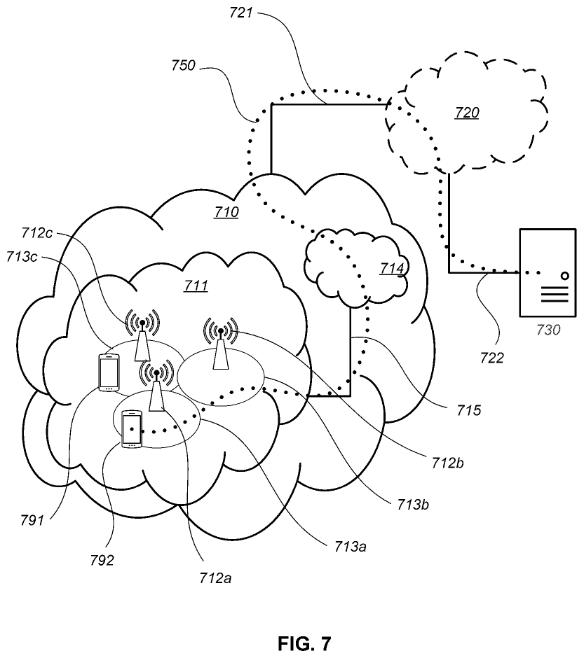

With reference to FIG. 7, in accordance with an embodiment, a communication system includes a telecommunication network 710, such as a 3GPP-type cellular network, which comprises an access network 711, such as a radio access network, and a core network 714. The access network 711 comprises a plurality of network nodes 712a. 712b. 712c, such as NBs, eNBs, gNBs or other types of wireless access points, each defining a corresponding coverage area 713a, 713b, 713c. Each network node 712a. 712b. 712c is connectable to the core network 714 over a wired or wireless connection 715. A first user equipment (UE) 791 located in coverage area 713c is configured to wirelessly connect to, or be paged by, the corresponding network node 712c. A second UE 792 in coverage area 713a is wirelessly connectable to the corresponding network node 712a. While a plurality of UEs 791, 792 are illustrated in this example, the disclosed embodiments are equally applicable to a situation where a sole UE is in the coverage area or where a sole UE is connecting to the corresponding network node 712.

The telecommunication network 710 is itself connected to a host computer 730, which may be embodied in the hardware and/or software of a standalone server, a cloud-implemented server, a distributed server or as processing resources in a server farm. The host computer 730 may be under the ownership or control of a service provider, or may be operated by the service provider or on behalf of the service provider. The connections 721, 722 between the telecommunication network 710 and the host computer 730 may extend directly from the core network 77 to the host computer 730 or may go via an optional intermediate network 720. The intermediate network 720 may be one of, or a combination of more than one of, a public, private or hosted network; the intermediate network 720, if any, may be a backbone network or the Internet: in particular, the intermediate network 720 may comprise two or more sub-networks (not shown).

The communication system of FIG. 7 as a whole enables connectivity between one of the connected UEs 791, 792 and the host computer 730. The connectivity may be described as an over-the-top (OTT) connection 750. The host computer 730 and the connected UEs 791, 792 are configured to communicate data and/or signaling via the OTT connection 750, using the access network 711, the core network 77, any intermediate network 720 and possible further infrastructure (not shown) as intermediaries. The OTT connection 750 may be transparent in the sense that the participating communication devices through which the OTT connection 750 passes are unaware of routing of uplink and downlink communications. For example, a network node 712 may not or need not be informed about the past routing of an incoming downlink communication with data originating from a host computer 730 to be forwarded (e.g., handed over) to a connected UE 791. Similarly, the network node 712 need not be aware of the future routing of an outgoing uplink communication originating from the UE 791 towards the host computer 730.

The UE 792 is configured to include at least an interpretation unit (not shown) as previously described.

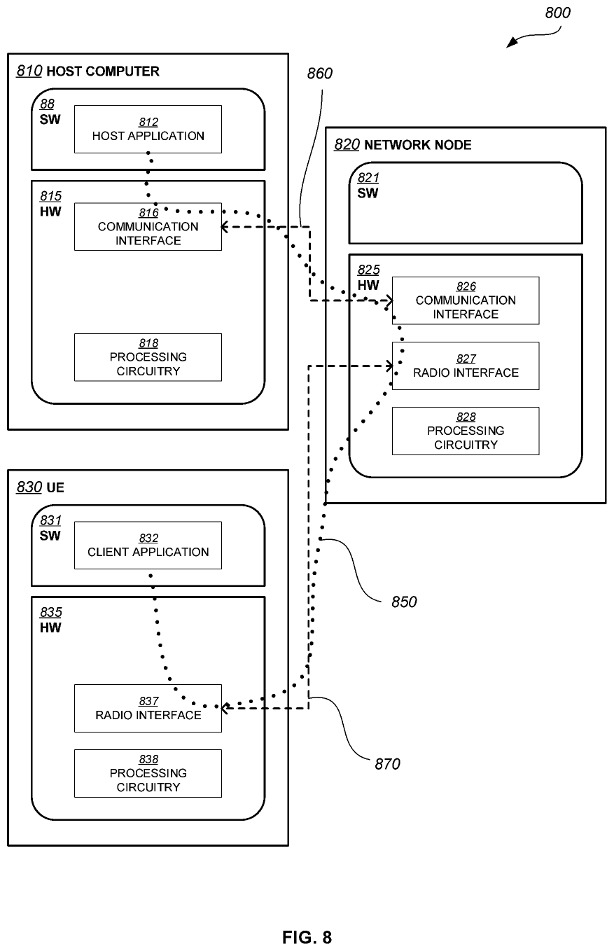

Example implementations, in accordance with an embodiment, of the UE, network node and host computer discussed in the preceding paragraphs will now be described with reference to FIG. 8. In a communication system 800, a host computer 810 comprises hardware 815 including a communication interface 816 configured to set up and maintain a wired or wireless connection with an interface of a different communication device of the communication system 800. The host computer 810 further comprises processing circuitry 818, which may have storage and/or processing capabilities. In particular, the processing circuitry 818 may comprise one or more programmable processors, application-specific integrated circuits, field programmable gate arrays or combinations of these (not shown) adapted to execute instructions. The host computer 810 further comprises software 88, which is stored in or accessible by the host computer 810 and executable by the processing circuitry 818. The software 88 includes a host application 812. The host application 812 may be operable to provide a service to a remote user, such as a UE 830 connecting via an OTT connection 850 terminating at the UE 830 and the host computer 810. In providing the service to the remote user, the host application 812 may provide user data which is transmitted using the OTT connection 850.

The communication system 800 further includes a network node 820 provided in a telecommunication system and comprising hardware 825 enabling it to communicate with the host computer 810 and with the UE 830. The hardware 825 may include a communication interface 826 for setting up and maintaining a wired or wireless connection with an interface of a different communication device of the communication system 800, as well as a radio interface 827 for setting up and maintaining at least a wireless connection 870 with a UE 830 located in a coverage area (not shown in FIG. 8) served by the network node 820. The communication interface 826 may be configured to facilitate a connection 860 to the host computer 810. The connection 860 may be direct or it may pass through a core network (not shown in FIG. 8) of the telecommunication system and/or through one or more intermediate networks outside the telecommunication system. In the embodiment shown, the hardware 825 of the network node 820 further includes processing circuitry 828, which may comprise one or more programmable processors, application-specific integrated circuits, field programmable gate arrays or combinations of these (not shown) adapted to execute instructions. The network node 820 further has software 821 stored internally or accessible via an external connection.

The communication system 800 further includes the UE 830 already referred to. Its hardware 835 may include a radio interface 837 configured to set up and maintain a wireless connection 870 with a network node serving a coverage area in which the UE 830 is currently located. The hardware 835 of the UE 830 further includes processing circuitry 838, which may comprise one or more programmable processors, application-specific integrated circuits, field programmable gate arrays or combinations of these (not shown) adapted to execute instructions. The UE 830 further comprises software 831, which is stored in or accessible by the UE 830 and executable by the processing circuitry 838. The software 831 includes a client application 832. The client application 832 may be operable to provide a service to a human or non-human user via the UE 830, with the support of the host computer 810. In the host computer 810, an executing host application 812 may communicate with the executing client application 832 via the OTT connection 850 terminating at the UE 830 and the host computer 810. In providing the service to the user, the client application 832 may receive request data from the host application 812 and provide user data in response to the request data. The OTT connection 850 may transfer both the request data and the user data. The client application 832 may interact with the user to generate the user data that it provides.

It is noted that the host computer 810, network node 820 and UE 830 illustrated in FIG. 8 may be identical to the host computer 830, one of the network nodes 712a, 712b, 712c and one of the UEs 791, 792 of FIG. 7, respectively. This is to say, the inner workings of these entities may be as shown in FIG. 8 and independently, the surrounding network topology may be that of FIG. 7.

In FIG. 8, the OTT connection 850 has been drawn abstractly to illustrate the communication between the host computer 810 and the use equipment 830 via the network node 820, without explicit reference to any intermediary devices and the precise routing of messages via these devices. Network infrastructure may determine the routing, which it may be configured to hide from the UE 830 or from the service provider operating the host computer 810, or both. While the OTT connection 850 is active, the network infrastructure may further take decisions by which it dynamically changes the routing (e.g., on the basis of load balancing consideration or reconfiguration of the network).

The wireless connection 870 between the UE 830 and the network node 820 is in accordance with the teachings of the embodiments described throughout this disclosure. One or more of the various embodiments improve the performance of OTT services provided to the UE 830 using the OTT connection 850, in which the wireless connection 870 forms the last segment. More precisely, the teachings of these embodiments may reduce PDCCH detection time and complexity and thereby provide benefits such as reduced user waiting time and reduced power consumption at the UE.

A measurement procedure may be provided for the purpose of monitoring data rate, latency and other factors on which the one or more embodiments improve. There may further be an optional network functionality for reconfiguring the OTT connection 850 between the host computer 810 and UE 830, in response to variations in the measurement results. The measurement procedure and/or the network functionality for reconfiguring the OTT connection 850 may be implemented in the software 88 of the host computer 810 or in the software 831 of the UE 830, or both. In embodiments, sensors (not shown) may be deployed in or in association with communication devices through which the OTT connection 850 passes: the sensors may participate in the measurement procedure by supplying values of the monitored quantities exemplified above, or supplying values of other physical quantities from which software 88, 831 may compute or estimate the monitored quantities. The reconfiguring of the OTT connection 850 may include message format, retransmission settings, preferred routing etc.; the reconfiguring need not affect the network node 820, and it may be unknown or imperceptible to the network node 820. Such procedures and functionalities may be known and practiced in the art. In certain embodiments, measurements may involve proprietary UE signaling facilitating the host computer's 810 measurements of throughput, propagation times, latency and the like. The measurements may be implemented in that the software 88, 831 causes messages to be transmitted, in particular empty or ‘dummy’ messages, using the OTT connection 850 while it monitors propagation times, errors etc.

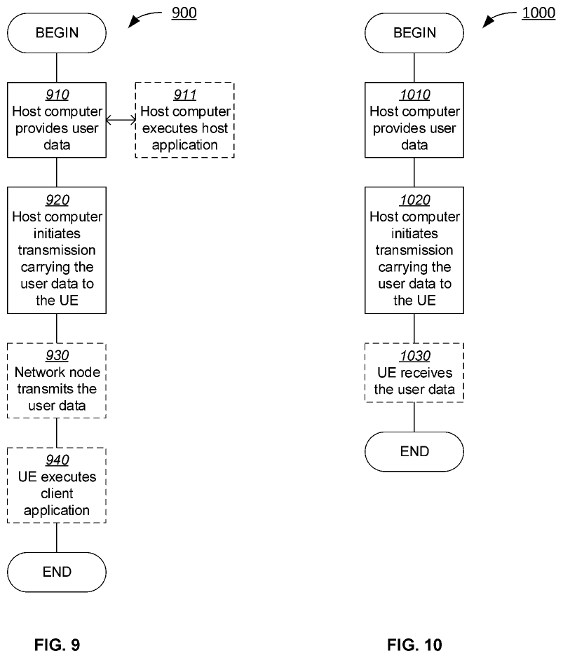

FIG. 9 is a flowchart illustrating a method 900 implemented in a communication system, in accordance with one embodiment. The communication system includes a host computer, a network node and a UE which may be those described with reference to FIGS. 7 and 8. For simplicity of the present disclosure, only drawing references to FIG. 9 will be included in this section. In a first step 910 of the method 900, the host computer provides user data. In an optional substep 911 of the first step 910, the host computer provides the user data by executing a host application. In a second step 920, the host computer initiates a transmission carrying the user data to the UE. In an optional third step 930, the network node transmits to the UE the user data which was carried in the transmission that the host computer initiated, in accordance with the teachings of the embodiments described throughout this disclosure. In an optional fourth step 940, the UE executes a client application associated with the host application executed by the host computer.

FIG. 10 is a flowchart illustrating a method 1000 implemented in a communication system, in accordance with one embodiment. The communication system includes a host computer, a network node and a UE which may be those described with reference to FIGS. 7 and 8. For simplicity of the present disclosure, only drawing references to FIG. 10 will be included in this section. In a first step 1010 of the method 1000, the host computer provides user data. In an optional substep (not shown) the host computer provides the user data by executing a host application. In a second step 1020, the host computer initiates a transmission carrying the user data to the UE. The transmission may pass via the network node, in accordance with the teachings of the embodiments described throughout this disclosure. In an optional third step 1030, the UE receives the user data carried in the transmission.

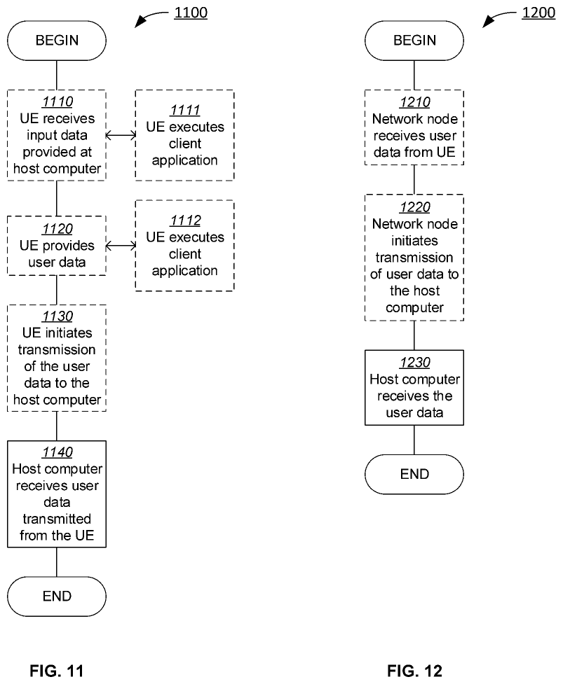

FIG. 11 is a flowchart illustrating a method 1100 implemented in a communication system, in accordance with one embodiment. The communication system includes a host computer, a network node and a UE which may be those described with reference to FIGS. 7 and 8. For simplicity of the present disclosure, only drawing references to FIG. 11 will be included in this section. In an optional first step 1110 of the method 1100, the UE receives input data provided by the host computer. Additionally or alternatively, in an optional second step 1120, the UE provides user data. In an optional substep 1112 of the second step 1120, the UE provides the user data by executing a client application. In a further optional substep 1111 of the first step 1110, the UE executes a client application which provides the user data in reaction to the received input data provided by the host computer. In providing the user data, the executed client application may further consider user input received from the user. Regardless of the specific manner in which the user data was provided, the UE initiates, in an optional third substep 1130, transmission of the user data to the host computer. In a fourth step 1140 of the method 1100, the host computer receives the user data transmitted from the UE, in accordance with the teachings of the embodiments described throughout this disclosure.

FIG. 12 is a flowchart illustrating a method 1200 implemented in a communication system, in accordance with one embodiment. The communication system includes a host computer, a network node and a UE which may be those described with reference to FIGS. 7 and 8. For simplicity of the present disclosure, only drawing references to FIG. 12 will be included in this section. In an optional first step 1210 of the method 1200, in accordance with the teachings of the embodiments described throughout this disclosure, the network node receives user data from the UE. In an optional second step 1220, the network node initiates transmission of the received user data to the host computer. In a third step 1230, the host computer receives the user data carried in the transmission initiated by the network node.

As will be appreciated by one of skill in the art, the concepts described herein may be embodied as a method, data processing system, computer program product and/or computer storage media storing an executable computer program. Accordingly, the concepts described herein may take the form of an entirely hardware embodiment, an entirely software embodiment or an embodiment combining software and hardware aspects all generally referred to herein as a “circuit” or “module.” Any process, step, action and/or functionality described herein may be performed by, and/or associated to, a corresponding module, which may be implemented in software and/or firmware and/or hardware. Furthermore, the present disclosure may take the form of a computer program product on a tangible computer usable storage medium having computer program code embodied in the medium that can be executed by a computer. Any suitable tangible computer readable medium may be utilized including hard disks, CD-ROMs, electronic storage devices, optical storage devices, or magnetic storage devices.

Some embodiments are described herein with reference to flowchart illustrations and/or block diagrams of methods, systems and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer (to thereby create a special purpose computer), special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory or storage medium that can direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations of the concepts described herein may be written in an object oriented programming language such as Java® or C++. However, the computer program code for carrying out operations of the present disclosure may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

It will be appreciated by persons skilled in the art that the embodiments described herein are not limited to what has been particularly shown and described herein above. In addition, unless mention was made above to the contrary, it should be noted that all of the accompanying drawings are not to scale. A variety of modifications and variations are possible in light of the above teachings.

1-48. (canceled)

49. A method at a User Equipment (UE), comprising:
in a case where the UE has a first type of SL message available for transmission,
obtaining a Sidelink (SL) grant, wherein the SL grant indicates resources belonging to a dedicated resource pool that is dedicated for transmission of the first type of SL message; and
performing actions related to the transmission of the first type of SL message on at least a part of the resources indicated in the SL grant, by taking into consideration priorities of Sidelink Logical Channels (SLCHs) used to carry the first type of SL message.

50. The method of claim 49, wherein said performing the actions comprises:
selecting a destination from a plurality of destinations to which the transmission of the first type of SL message is to be performed, based on a highest priority of SLCHs used to carry the first type of SL message that are associated with each of the plurality of destinations, wherein the selected destination has an SLCH with the highest priority; and
assigning the resources indicated in the SL grant to one or more SLCHs used to carry the first type of SL message that are associated with the selected destination, for the transmission of the first type of SL message, based on the priorities of the one or more SLCHs used to carry the first type of SL message that are associated with the selected destination.

51. The method of claim 49, wherein said performing the actions comprises:
in a case where prioritization between Uplink (UL) transmission and SL transmission is needed for the UE,
performing prioritization based on the highest priority of the one or more SLCHs carrying or used to carry the first type of SL message and a highest priority of one or more Logical Channels ‘LCHs’ carrying or used to carry UL messages; and
performing transmission of the UL messages if the UL transmission is prioritized, otherwise performing the transmission of the first type of SL message.

52. The method of claim 51, wherein
the transmission of the first type of SL message is performed if the highest priority of the one or more SLCHs carrying or used to carry the first type of SL message is smaller than an SL prioritization threshold, while the highest priority of the one or more LCHs carrying or used to carry the UL message is larger than an UL prioritization threshold; and
the transmission of the UL messages is performed, if the highest priority of the one or more SLCHs carrying or used to carry the first type of SL message is larger than an SL prioritization threshold, or the highest priority of the one or more LCHs carrying or used to carry the type of UL message is smaller than an UL prioritization threshold.

53. The method of claim 49, wherein said performing the actions comprises:
building an SL Media Access Control ‘MAC’ Protocol Data Unit ‘PDU’ only comprising the one or more SLCHs used to carry the first type of SL message.

54. The method of claim 49, further comprising: obtaining configuration on SL transmission parameters; and wherein
said performing the actions comprises:
selecting SL transmission parameters for the transmission of the first type of SL message based on the highest priority of the SLCHs used to carry the first type of SL message.

55. The method of claim 49, wherein
said obtaining the SL grant comprises: receiving the SL grant from a network node, and
the method further comprises: identifying whether the resources indicated in the SL grant belong to the dedicated resource pool for the transmission of the first type of SL message based on one of:
a pool ID comprised in Downlink Control Information ‘DCI’ for indicating a resource pool associated with the SL grant, in a case where the SL grant is a dynamic SL grant; and
pool configuration in Radio Resource Control ‘RRC’ signaling, in a case where the SL grant is a configured SL grant, wherein the pool configuration is associated to a pool ID for indicating a resource pool.

56. The method of claim 49, wherein said obtaining the grant comprises generating the SL grant based on the resources selected from the dedicated resource pool, the method further further comprising:
performing resource selection in the dedicated resource pool based on channel sensing, by taking into consideration the priorities of the SLCHs carrying or used to carry the first type of SL message.

57. The method of claim 56, wherein said performing resource selection comprises:
decoding Sidelink Control Information ‘SCI’ transmitted on an SL control channel from a sensed UE to know resources on which an associated SL data channel is transmitted by the sensed UE and the highest priority of the SLCH associated with the SL data channel; and
determining availability of the resources in the dedicated resource pool on which the SL data channel is transmitted, based on comparison of a measured value of link quality of the SL control channel with a predetermined threshold of link quality, wherein the predetermined threshold of link quality is set based on the highest priority of the SLCHs carrying or used to carry the first type of SL message.

58. The method of claim 49, wherein said obtaining the grant comprises generating the SL grant based on the resources selected from the dedicated resource pool, the method further comprising:
obtaining configuration on preemption of resources in the dedicated resource pool that are preserved by SCI received from a neighbor UE, for the transmission of the first type of SL message that is allowed to use resources in the dedicated resource pool for transmission; and
in the case where the UE has the first type of SL message available for transmission,
comparing a highest priority of SLCHs carrying or used to carry the first type of SL message with a priority indicated in the received SCI; and
determining to preempt the resources preserved by the received SCI, if the highest priority of the SLCHs carrying or used to carry the first type of SL message is higher than the priority indicated in the received SCI.

59. The method of claim 49, wherein the dedicated resource pool and a shared resource pool are configured by a network node or preconfigured in the UE for the transmission of the first type of SL message, and wherein the method further comprises:
performing pool selection between the dedicated resource pool and the shared resource pool according to at least one of selection criteria, in which
the shared resource pool is selected, if the UE has available for transmission both the first type of SL message and a second type of SL message that is not allowed to use the resources in the dedicated resource pool for transmission, or if the UE has available for transmission only the second type of SL message; while the dedicated resource pool is selected if the UE has available for transmission only the first type of SL message;
the shared resource pool is selected if the highest priority of the SLCHs used to carry the first type of SL message is not higher than that of SLCHs used to carry the second type of SL message, while the dedicated resource pool is selected if the highest priority of the SLCHs used to carry the first type of SL message is higher than that of SLCHs used to carry the second type of SL message;
a type of resource pool with a higher priority is selected, wherein a resource pool is randomly selected or a resource pool with a lowest congestion is selected if there are a plurality of resources pools belonging to the selected pool type, in a case where different priority values are configured by the network node or preconfigured in the UE respectively for the dedicated resource pool and the shared resource pool;
a type of resource pool is selected according to configuration by the network node or preconfiguration in the UE, in which case a resource pool is randomly selected or a resource pool with a lowest congestion is selected if there are a plurality of resources pools belonging to the selected pool type;
a resource pool with a lower congestion is selected, regardless of the type of the pool;
the UE transmits a preference indication on the pool selection to the network node, receives acceptance of the preference indication from the network node, and selects a type of resource pool based on the preference indication;
the UE transmits a preference indication on the pool selection to the network node, receives another preference indication from the network node, and selects a type of resource pool based on the received preference indication;
it is up to implementation of the UE to select which type of resource pool.

60. The method of claim 59, further comprising:
receiving separate Scheduling Request ‘SR’ configurations associated with different types of resource pools respectively; and
transmitting an SR for signaling the preference indication using one of the separate SR configurations, in a case where the UE has the first type of SL message available for transmission.

61. The method of claim 49, further comprising:
receiving, from the network node, configuration on a specific SL Logical Channel Group ‘SLCG’ that at least comprise an SLCH used to carry the first type of SL message; and
transmitting, to the network node, an SL Buffer Status Report ‘BSR’ comprising the configured specific SLCG in the case where the UE has the first type of SL message available for transmission.

62. The method of claim 49, further comprising:
receiving, from the network node, configuration on an SR that is associated with an SLCH and/or SLCG used to carry the first type of SL message; and
triggering the configured SR, in the case where the UE has the first type of SL message available for transmission; and
transmitting the configured SR to the network node.

63. The method of claim 49, further comprising:
in a case where the highest priority of SLCHs used to carry the first type of SL message is lower than the highest priority of SLCHs used to carry a second type of SL message that is not allowed to use the dedicated resource pool for transmission, or
in a case where the UE has available for transmission only a second type of SL message that is not allowed to use the dedicated resource pool for transmission, and the UE has only an available SL grant indicating resources belonging to the dedicated resource pool,
triggering an SR for requesting additional resources for the second type of SL message; and
transmitting the SR to the network node.

64. The method of claim 49, wherein the dedicated resource pool and a shared resource pool are configured by a network node or preconfigured in the UE for the transmission of the first type of SL message, and wherein the method further comprises:
after the type of resource pool is selected, switching to another type of resource pool due to at least one of reasons of:
congestion in the selected resource pool being higher than a predetermined threshold,
measured transmission performance using the selected resource pool become being higher than a threshold,
measured Quality of Service ‘QoS’ metrics using the selected resource pool not meeting specific requirements,
services/applications/traffic types that are associated with different resource pools and have available data having changed, or
the UE's battery life having changed.

65. A method at a network node, comprising:
transmitting, to a User Equipment ‘UE’, configuration on transmission of a first type of Sidelink ‘SL’ message that is allowed to use resources in a dedicated resource pool for transmission; and
transmitting an SL grant to the UE, wherein the SL grant indicates resources belonging to the dedicated resource pool that is dedicated for the transmission of the first type of SL message.

66. The method of claim 65, wherein the configuration comprises: configuration on preemption of resources in the dedicated resource pool that are preserved by SCI received from a neighbor UE for the transmission of the first type of SL message that is allowed to use resources in the dedicated resource pool for transmission.

67. The method of claim 65, wherein the dedicated resource pool and a shared resource pool are configured by a network node for the transmission of the first type of SL message, the method further comprising:
performing pool selection between the dedicated resource pool and the shared resource pool according to at least one of selection criteria, in which
the shared resource pool is selected, if the UE has available for transmission both the first type of SL message and a second type of SL message that is not allowed to use the resources in the dedicated resource pool for transmission, or if the UE has available for transmission only the second type of SL message; while the dedicated resource pool is selected if the UE has available for transmission only the first type of SL message;
the shared resource pool is selected if the highest priority of the SLCHs used to carry the first type of SL message is not higher than that of SLCHs used to carry the second type of SL message, while the dedicated resource pool is selected if the highest priority of the SLCHs used to carry the first type of SL message is higher than that of SLCHs used to carry the second type of SL message;
a type of resource pool with a higher priority is selected, wherein a resource pool is randomly selected or a resource pool with a lowest congestion is selected if there are a plurality of resources pools belonging to the selected pool type, in a case where different priority values are configured by the network node respectively for the dedicated resource pool and the shared resource pool;
a type of resource pool is selected according to configuration by the network node, in which case a resource pool is randomly selected or a resource pool with a lowest congestion is selected if there are a plurality of resources pools belonging to the selected pool type;
a resource pool with a lower congestion is selected, regardless of the type of the pool;
the network node receives a preference indication from the UE on the pool selection, and selects a type of resource pool taking into consideration the preference indication;
the network node receives the preference indication from the UE on the pool selection, and transmits acceptance of the preference indication to the UE;
it is up to implementation of the network node to select which type of resource pool.

68. A User Equipment (UE) comprising:
at least one processor, and
at least one memory, storing instructions which, when executed on the at least one processor, cause the UE to:
in a case where the UE has a first type of SL message available for transmission,
obtain a Sidelink ‘SL’ grant, wherein the SL grant indicates resources belonging to a dedicated resource pool that is dedicated for transmission of the first type of SL message; and
perform actions related to the transmission of the first type of SL message on at least a part of the resources indicated in the SL grant, by taking into consideration priorities of Sidelink Logical Channels ‘SLCHs’ used to carry the first type of SL message.
